(19) United States
(12) Patent Application Publication
(10) Pub. No.: US 2015/0065347 A1
(43) Pub. Date: Mar. 5, 2015

(54) CO-CRYSTALS OF DICAMBA AND A CO-CRYSTAL FORMER B

(71) Applicant: BASF SE, Ludwigshafen (DE)

(72) Inventors: Tiziana Chiodo, Mannheim (DE); Evgueni Klimov, Ludwigshafen (DE); Ansgar Schaefer, Karlsruhe (DE); Hans Wolfgang Hoeffken, Ludwigshafen (DE); Rolf Hellman, Lustadt (DE); Andre Kabat, Hassloch (DE); Rafel Israels, Koeln (DE); Gerhard Schnabel, Elsenfeld (DE); Matthias Bratz, Maxdorf (DE); Christine Kibat, Limburgerhof (DE); Wolfgang Houy, Ludwigshafen (DE)

(21) Appl. No.: 14/388,462

(22) PCT Filed: Mar. 20, 2013
(86) PCT No.: PCT/EP2013/055762

§ 371 Date: Sep. 26, 2014

Related U.S. Application Data
(60) Provisional application No. 61/617,064, filed on Mar. 29, 2012.

(51) Int. Cl. A01N 37/40; A01N 57/20; A01N 25/12

(52) U.S. Cl. CPC A01N 37/40; A01N 25/12; A01N 57/20
USPC 504/127; 562/471; 504/324

(57) ABSTRACT

Co-crystals comprising
a) a herbicide compound A, which is 3,6-dichloro-2-methoxybenzoic acid (dicamba), and
b) a co-crystal former B, which is selected from the group of aromatic, N-containing heterocycles; and their use in agrochemical compositions.

The present invention relates to co-crystals of organic compounds. In particular, the invention relates to co-crystals of a herbicide compound A and a co-crystal former B. It also relates to agrochemically useful compositions comprising these co-crystals.

Co-crystals of organic compounds, or crystalline complexes, are multi-component crystals or crystalline materials that consist of at least two different organic compounds.

They are usually solid or at least a non-volatile oil (vapour pressure less than 1 mbar) at 25° C. In the co-crystals, at least two different organic compounds form a crystalline material having a defined crystal structure, i.e. at least two organic compounds have a defined relative spatial arrangement within the crystal structure.

In the co-crystals, at least two different compounds interact by non-covalent bonding, hydrogen bonds and/or other non-covalent intermolecular forces, including Tr-stacking, dipole-dipole interactions and van der Waals interactions.

Although the packing in the crystalline lattice cannot be designed or predicted, several supramolecular synthons were successfully recognized in co-crystals. The term “supramolecular synthon” has to be understood as an entity of usually two compounds that are bonded together via non-covalent interactions, in the most typical case hydrogen bonding. In co-crystals these synthons further pack in the crystalline lattice to form a molecular crystal. Molecular recognition is one condition of the formation of the synthon. However, the co-crystal must also be energetically favourable, i.e. an energy win in the formation of the co-crystal is also required, as molecules typically can pack very efficiently as crystals of pure components thereby hindering the co-crystal formation.

In co-crystals, one of the organic compounds may serve as a co-crystal former, i.e. a compound which itself easily forms a crystalline material and which is capable of forming co-crystals with other organic compounds, which themselves may not necessarily form a crystalline phase.

Agrochemically active organic compounds (pesticides) such as fungicides, herbicides and insecticides or acaricides are usually marketed as liquid or solid formulations, which comprise one or more agrochemically active organic compounds and suitable formulation additives. For several reasons, formulation types are preferred, wherein the agrochemically active organic compound is present in the solid state. Examples include solid formulations such as dusts, powders or granules and liquid formulations such as suspension concentrates, i.e. aqueous compositions containing the pesticide as fine particles, which are dispersed in the aqueous medium, or suspo-emulsions, i.e. aqueous compositions containing one pesticide as fine particles, which are dispersed in the aqueous medium and a further pesticide solubilized in an organic solvent. Suspension concentrates or suspo-emulsions have the desirable characteristics of a liquid that may be poured or pumped and which can easily be diluted with water to the desired concentration required for application. In contrast to emulsion concentrates, the suspension concentrates have the added advantage of not requiring the use of water-immiscible organic solvents. Suspo-emulsions have the advantage of providing the possibility to formulate more than one pesticide in the same concentrate—besides the first active—present in the form of fine particles—the second active can be present solubilized in an organic liquid.

Solid formulations such as granules, powders or any other solid concentrates have the advantage that the pesticide can be formulated at a higher concentration, resulting in lower production and packaging costs.

For purposes of such solid state formulations, the respective agrochemically active organic compound(s) should be crystalline material(s) having a sufficiently high melting point.

Unfortunately, a large number of these organic compounds are amorphous materials resulting in processing difficulties, formulation instabilities and application unreliability due to caking and settling of the fine particles.

A further problem associated with liquid formulations comprising solid pesticides results from the tendency of crystalline material to form large crystals upon aging (“Oswald ripening”) resulting in an increased settling of solid pesticide particles and thus in an instability, difficulty in processing and unreliability of usage. Herein, also the morphology of a crystal modification of the pesticide may influence the behaviour of the pesticide in formulation and may even result in different end use properties. For example, a different shape of the pesticide co-crystals in comparison to the pure pesticide crystal may influence the aging process. These problems become most serious when storing respective granules, powders, or other solid concentrates or the suspension concentrates or suspo-emulsions at elevated temperatures above 35° C. and especially above 40° C.

Many pesticides have unsatisfactory low melting points. However, a low melting point does not only complicate the current formulation processes for suspension concentrates and suspo-emulsions or granules, but might also negatively affect the final formulation stability.

Besides the issue of melting point increase, there are further tasks the formulation chemist is confronted with.

The development of a stable pesticidal formulation, which also exhibits satisfactory pesticidal action, is a challenge for the skilled artisan. A central parameter in formulation technology is the control of physico-chemical properties of the pesticide, both in the formulation per se and the application form of the formulation, e.g. in tank mix, wherein the respective formulation is diluted with water. On the one hand, the high efficacy of the pesticide, which is required for control of the respective target organism or plant, may have—if not controlled via formulation technology—negative side effects such as toxicity to not-target organisms or agrochemical useful plants. Further unwanted physico-chemical properties of pesticides are decay due to processes like breakdown, evaporation and leaching. Thus, the object of formulation technology is both controlling the physico-chemical parameters in a way that the pesticide is sufficiently available in a stable formulation concentrate and avoiding unwanted side effects such as phytotoxicity or toxicity against useful target organisms.

Unfortunately, the techniques available for the skilled artisan to alter the physicochemical properties of a pesticide are very limited.

For example, the reduction of availability of the pesticide, which in high concentration has also unwanted side effects as described above, can be achieved via encapsulation technologies. These technologies, however, have been proven to be very difficult to turn into commercial products due to lack of adequate technical means and/or due to the resulting price of such technology (e.g. as in the case of complexation with cyclodextrins).

It is even more difficult to adjust the availability of a pesticide via formulation technology. Decreased availability of the pesticide could however result in desired properties such as reduced leaching of residual pesticide into the ground water.

Formation of co-crystals has been discussed in the past few years as a further potential tool to trigger the availability and stability of the pesticide in formulations, to adjust the availability of a pesticide by amending its physico-chemical properties (such as altered water solubility, melting point, vapour pressure via complexation of the pesticide) with a suitable co-crystal former.

However, in most cases, this option is mostly theoretical. Suitable crystalline complexes are known in the art for only a few pesticides. They are very difficult to find for currently used compounds, and the physico-chemical properties of the complexes are not predictable.

Generally, an increased pesticidal action (e.g. fungicidal or herbicidal action) in comparison to the solo pesticide is highly desirable, as this may lead to a reduction of the application rates.

Furthermore, a reduced phytotoxicity, which may result in a positive impact on the germination rate in the area of seed treatment, such as an increase of the germination rate of at least 3%, more preferably at least 5%, is a highly desired property for the farmer.

Thus, there is a constant need in the art to find novel co-crystals of pesticides, which have modified physicochemical properties, in comparison to the solid state modifications of the pure pesticides.

Crystalline forms of dicamba are known [G Smith, E J O'Reilly, CHL Kennard, Aust. J. Chem. 1983, 36, 2175]. Salts of dicamba are known from WO 2012/006313.

However, also in these cases, amended physico-chemical properties are highly appreciated as they provide the skilled formulation chemist new tools for developing even better formulations as those currently used in the market.

The object of the present invention was therefore to provide novel co-crystals of dicamba, which show
a) reduced availability of dicamba by decreasing its water solubility; and/or,
b) increased availability of dicamba; and/or
c) an increased melting point and/or
d) enhanced stability in formulations; and/or
e) change the morphology of the crystals; and/or
f) a reduced vapour pressure and/or
g) enhanced pesticidal action and/or
h) increased germination rate.

This object has been solved by co-crystals comprising
a) a herbicide compound A, which is 3,6-dichloro-2-methoxybenzoic acid (dicamba); and
b) a co-crystal former B, which is selected from the group of aromatic, N-containing heterocycles.

The co-crystals according to the invention each show at least one of the afore-mentioned properties a), b), c), d), e), f) or g), preferably at least one of the afore-mentioned properties a) c), d), e), f), in particular at least one of the afore-mentioned properties a), c) and f).

According to a preferred embodiment of the invention, the co-crystal former B is selected from the group of basic aromatic, N-containing heterocycles.

In basic aromatic, N-containing heterocycles, the lone pair of electrons is not part of the aromatic system and extends in the plane of the ring.

According to a particularly preferred embodiment of the invention, the ΔpKa value of the co-crystal former B, which selected from the group of basic aromatic, N-containing heterocycles, and the herbicide compound A, i.e. (pKa (co-crystal formerB)−pKa (a herbicide compound A)), is ≦3.

The basic aromatic, N-containing heterocycles are selected from 5- or 6-membered monocyclic or 9- or 10-membered bicyclic aromatic heterocycles, which may contain in addition to a first nitrogen 1, 2, or 3 heteroatoms selected from the group consisting of O, N and S. From among these, preference is given to 5- or 6-membered heterocycles.

The basic aromatic, N-containing heterocycles may be unsubstituted or substituted by one or more groups selected from C₁-C₄-alkyl, amino, hydroxyl, heterocyclyl and/or a bicyclic ring system may be formed with a fused-on phenyl ring or with a C₃-C₆-carbocycle or with a further 5- to 6-membered heterocycle.

Non-limiting examples for basic aromatic, N-containing heterocycles are imidazoles, benzimidazoles, purines, pyrazoles, indazoles, oxazoles, benzoxazoles, isoxazoles, benzisoxazoles, thiazoles, benzthiazoles, pyridines, quinolines, isoquinolines, pyrazines, quinoxazlines, acridines, pyrimidines, quinazolines, pyridazines and cinnolines.

Non-limiting specific examples for suitable co-crystal formers B are the following compounds:

| | |
|---|---|
| 1 | caffeine |
| 2 | theophylline |
| 3 | 2-aminopyrimidine |
| 4 | 4-aminopyrimidine |
| 5 | 2-aminothiazole |
| 6 | 3-hydroxypyridine |
| 7 | isocytosine |
| 8 | 4,4′-bipyridine |

Thus, the present invention relates to co-crystals comprising dicamba and caffeine (herein below referred to as “Complex I”).

In a further embodiment, the present invention relates to co-crystals comprising dicamba and theophylline (herein below referred to as “Complex II”).

In a further embodiment, the present invention relates to co-crystals comprising dicamba and 2-aminopyrimidine (herein below referred to as “Complex III”).

In a further embodiment, the present invention relates to co-crystals comprising dicamba and 4-aminopyrimidine (herein below referred to as “Complex IV”).

In a further embodiment, the present invention relates to co-crystals comprising dicamba and 2-aminothiazole (herein below referred to as “Complex V”).

In a further embodiment, the present invention relates to co-crystals comprising dicamba and 3-hydroxypyridine (herein below referred to as “Complex VI”).

In a further embodiment, the present invention relates to co-crystals comprising dicamba and isocytosine (herein below referred to as “Complex VII”).

In a further embodiment, the present invention relates to co-crystals comprising dicamba and 4,4′-bipyridine (herein below referred to as “Complex VIII”).

### Co-Crystals:

In particular, Complex I, Complex II, Complex VII and Complex VIII show decreased solubility in water, in comparison crystalline dicamba. This facilitates the production of SC and/or SE or granular formulations.

Complex II, Complex VI, Complex VII and Complex VIII maintain the beneficial properties of dicamba while markedly lowering the volatility.

In addition, Complex II, Complex IV, Complex V, Complex VI and Complex VII show an increased melting point, in comparison to crystalline dicamba. This facilitates the production of SC and/or SE formulations or granular formulations.

Preferred are the co-crystals Complex II, Complex VI, Complex VII and Complex VIII, more preferred are co-crystals Complex II, Complex VII and Complex VIII, most preferred are co-crystals Complex II and Complex VII.

In Complex I, the molar ratio of dicamba and caffeine is generally in the range from 2:1 to 1:2, preferably from 1.5:1 to 1:1.5, and in particular from 1:1.

However, deviations are possible, though they will generally not exceed 20 mol-% and preferably not exceed 10 mol-%.

In Complex II, the molar ratio of dicamba and theophylline is generally in the range from 2:1 to 1:2, preferably from 1.5:1 to 1:1.5, and in particular from 1:1. However, deviations are possible, though they will generally not exceed 20 mol-% and preferably not exceed 10 mol-%.

In Complex III, the molar ratio of dicamba and 2-aminopyrimidine is generally in the range from 10:1 to 1:10, preferably from 4:1 to 1:4, more preferably from 2:1 to 1:2 (e.g. ratios such as 1:2, 2:1, 1:1).

However, deviations are possible, though they will generally not exceed 20 mol-% and preferably not exceed 10 mol-%.

In Complex IV, the molar ratio of dicamba and 4-aminopyrimidine is generally in the range from 10:1 to 1:10, preferably from 4:1 to 1:4, more preferably from 2:1 to 1:2 (e.g. ratios such as 1:2, 2:1, 1:1).

However, deviations are possible, though they will generally not exceed 20 mol-% and preferably not exceed 10 mol-%.

In Complex V, the molar ratio of dicamba and 2-aminothiazole is generally in the range from 10:1 to 1:10, preferably from 4:1 to 1:4, more preferably from 2:1 to 1:2 (e.g. ratios such as 1:2, 2:1, 1:1).

However, deviations are possible, though they will generally not exceed 20 mol-% and preferably not exceed 10 mol-%.

In Complex VI, the molar ratio of dicamba and 3-hydroxypyridine is generally in the range from 10:1 to 1:10, preferably from 4:1 to 1:4, more preferably from 2:1 to 1:2 (e.g. ratios such as 1:2, 2:1, 1:1).

However, deviations are possible, though they will generally not exceed 20 mol-% and preferably not exceed 10 mol-%.

In Complex VII, the molar ratio of dicamba and isocytosine are generally in the range from 10:1 to 1:10, preferably from 4:1 to 1:4, more preferably in the range from 2:1 to 1:2 (e.g. ratios such as 1:2, 2:1, 1:1).

However, deviations are possible, though they will generally not exceed 20 mol-% and preferably not exceed 10 mol-%.

In Complex VIII, the molar ratio of dicamba and 4,4′-bipyridine are generally in the range from 10:1 to 1:10, preferably from 4:1 to 1:4, more preferably in the range from 2:1 to 1:2 (e.g. ratio such 1:2).

However, deviations are possible, though they will generally not exceed 20 mol-% and preferably not exceed 10 mol-%.

The co-crystals can be distinguished from simple mixtures of crystalline dicamba and the respective co-crystal former B by standard analytical means used for the analysis of crystalline material, including X-ray powder diffractometry (PXRD), single crystal X-ray diffractometry (when single crystals of sufficient quality are available) and thermochemical analysis such as thermogravimetry (TGA) and differential scanning calorimetry (DSC) or by spectrometrical methods, such as solid state NMR (for example ¹³C CPMAS), FT-IR or Raman. Relative amounts of dicamba and the respective co-crystal former B can be determined e.g. by HPLC or by ¹H-NMR-spectroscopy.

The present invention also comprises a process for preparing the co-crystals or crystalline complexes according to the present invention, which comprises combining the herbicide compound A and the co-crystal former B in suitable solvent.

In one embodiment of the present invention, hereinafter referred to as “Solution process” the herbicide compound A and the co-crystal former B are completely dissolved in a suitable solvent, wherein in a second step co-crystallization is induced by cooling (“Cooling process”) or evaporation (“Evaporation process”) or precipitation (“Precipitation process”).

In a further embodiment of the present invention, hereinafter referred to as “Shear process” the herbicide compound A and the co-crystal former B are combined together and subsequently shear forces are applied to the combined co-crystal former B and herbicide compound A.

In a further embodiment of the present invention, hereinafter referred to as “Slurry process” the herbicide compound A and the co-crystal former B are suspended in a suitable solvent and sheared (e.g. with a rotor-stator mill).

In all of the preparation process variants, the respective liquid media used may also include additives which are usually present in agrochemical formulations. Suitable additives are described hereinafter and include surfactants, in particular anionic or non-ionic emulsifiers, wetting agents and dispersants usually employed in crop protection compositions, furthermore antifoam agents, antifreeze agents, agents for adjusting the pH, stabilizers, anticaking agents, dyes and biocides (preservatives). The amount of the individual components will vary depending on the final formulation type. Examples of these auxiliaries are set forth herein below.

a) As described above, the “Solution process” is to be understood as a process where the co-crystal former B and the herbicide compound A are fully dissolved in a solvent system at a specific temperature and where the crystallization of the co-crystal is induced either by a cooling, evaporation or precipitation processes.

Herein, saturated solutions of the co-crystal former B and the herbicide compound A can be prepared separately at an elevated temperature (for example in the case of dicamba in the range of 50° C. to 120° C. Afterwards, both solutions can be combined at the same temperature and cooled down to 0° C. to 20° C., preferably to 3° C. to 8° C. (e.g. 5° C.). The so-formed co-crystals can be separated from the resulting suspension by conventional techniques (e.g. filtration). This process is herein below after referred to as “Cooling Process”. The co-crystal former B and the herbicide compound A can also be dissolved at elevated temperature simultaneously in the same vessel and then applying the above described cooling process. Herein, the absolute amounts and ratio of the co-crystal former B and the herbicide compound A need to be chosen case by case depending of the phase diagram of the system in the corresponding solvent system, considering for example the solubility of the compounds, the ratio of the co-crystal and possibility for polymorphism and solvate formation. Preferred solvents are those, where dicamba and the co-crystal former B have a comparable solubility. Comparable solubility means that the solubilities of the individual compounds in the solvent or solvent system differ preferably not more than 20%, more preferably not more than 10% and in particular not more than 5%.

In an evaporation crystallization (“Evaporation process”), the solution of the co-crystal former B and the herbicide compound A is prepared in accordance with the conditions set forth for the Cooling process with the following differences:
1. in the Evaporation process, lower temperatures can be used in comparison to the Cooling process.
2. in the Evaporation process, dicamba and the co-crystal former B should have a similar solubility in the solvent. Similar solubility means that the solubilities of the individual compounds in the solvent or solvent system differ by not more than 10%, in particular by not more than 5%.

After dissolving the two components in the selected solvent, the solvent is removed by using commonly used evaporation techniques (e.g. heating or reduced pressure).

In a precipitation crystallization (“Precipitation process”) the co-crystal former B is brought into solution with the herbicide compound A as described above for Cooling process and Evaporation process. The crystallization is induced by lowering the solubility of the solvent system by addition of a solvent, in which the solubility of the co-crystal former B and solubility of dicamba is preferably lower than 10 g/l and in particular lower than 2 g/l at room temperature (herein below referred to as “anti-solvent”). A convenient suitable anti-solvent is a non-polar solvent, e.g. hexane or heptane. The amount of the anti-solvent and method of addition (step wise or over a longer period) depend on the co-crystal former B and the used solvent system. Suitable solvents for the Precipitation process are miscible at least with the anti-solvent.

Generally, the co-crystal former B needs to be sufficiently soluble in the solvent, which means a solubility of the co-crystal former B of more than 10 g/l, more preferably between 100 g/l and 500 g/l at 20° C.

Suitable solvents for the Cooling Process and the Evaporation Process are organic solvents having a water miscibility of at least 10% at room temperature (“polar organic solvents”) or mixtures of water with a polar organic solvents or organic solvents having a water miscibility of below 10% at room temperature (“non-polar organic solvents”). Suitable solvents for the Precipitation process are organic solvents that are miscible with the selected solvent.

Examples of polar and non-polar organic solvents are those listed below.

Suitable polar organic solvents include, but are not limited to:
1. C₁-C₄-Alkanols such as methanol, ethanol, n-propanol or isopropanol;
2. Amides, N-methylamides and N,N-dimethylamides of C₁-C₃-carboxylic acids such as formamide, dimethylformamide (DMF), acetamide and N,N-dimethylacetamide;
3. 5- or 6-membered lactames with a total of 7 carbon atoms such as pyrrolidone, N-methylpyrrolidone, N-ethylpyrrolidone, N-isopropylpyrrolidone, Nhydroxyethylpyrrolidone;
4. Dimethylsulfoxid and sulfolane;
5. Ketones with 3 to 6 carbon atoms such as acetone, 2-butanone, cyclopentanone and cyclohexanone;
6. Acetonitrile;
7. 5- or 6-membered lactones such as γ-butyrolactone;
8. Polyols and polyetherols such as glycol, glycerin, dimethoxyethan, ethylendiglycol, ethylenglycolmonomethylether, etc;
9. Cyclic carbonates having 3 to 5 carbon atoms including propylene carbonate and ethylene carbonate; and
10. Dimethyl-(poly)C₂-C₃-alkyleneglycol ethers such as dimethoxyethane, diethyleneglycoldimethylether, triethyleneglycoldimethylether, dipropyleneglycoldimethylether, low molecular weight polyethyleneglycoles and low molecular weight polypropyleneglycoles (MW 5400).

More preference is given to organic solvents of the group 1, and to their mixtures with water. In the mixtures with water the relative amount of organic solvent and water may vary from 200:1 to 1:200 (v/v), in particular from 1:5 to 1:100 (v/v).

An especially suitable polar organic solvent to be used alone or in mixture with water is an alcohol as mentioned above (C₁-C₄-alkanols such as methanol, ethanol, n-propanol or isopropanol)

Example of non-polar solvents include, but are not limited to C₈ to C₁₁ aromatic petroleum derivatives (aromatic hydrocarbons) with a solubility in water <0.1%(w/w) and a distillation range from 130° C. to 300° C. (commercially available under the following brand names: Solvesso 100, Solvesso 150, Solvesso 200, Solvesso 150ND, solvesso 200ND, Aromatic 150, Aromatic 200, Hydrosol A 200, Hydrosol A 230/270, Caromax 20, Caromax 28, Aromat K 150, Aromat K 200, Shellsol A 150, Shellsol A 100, Fin FAS-TX 150, Fin FAS-TX 200), vegetable oils such as coco oil, palm kern oil, palm oil, soya oil, rapeseed oil, corn oil and the methyl or ethyl esters of the afore-mentioned oils, hydrocarbons such as aromatic depleted, linear paraffinic, isoparaffinic, cycloparaffinic having a flash point between 40° C. and 250° C. and a distillation range from 150° C. to 450° C.

b) As set forth above, in the “Shear process”, the co-crystal is obtained by applying shear forces to the two components of the co-crystal.

In this process, the co-crystal former B and dicamba are combined in a suitable solvent provided, however, that the co-crystal former B and dicamba are not dissolved and still in the solid stage. Principally, it is also possible to combine the co-crystal former B and dicamba in a solid stage without any solvent and applying shear forces afterwards to the thus obtained solid mixture. Suspending in a suitable solvent is preferred.

Applying shear forces to the thus obtained suspension is preferably performed at a temperature of at least 15° C., frequently at a temperature of at least 20° C., preferably at a temperature of at least 30° C., in particular of at least 35° C., e.g. from 15° C. to 80° C., wherein the upper limit depends on the melting points of the co-crystal former B and dicamba.

However, it is not necessary for the co-crystal former B to be solid during the process and it might be advantageous, if the temperature is close to or above the melting point of the co-crystal former B. Upon applying shear forces to the liquid mixture at elevated temperatures, the formation of the co-crystal might be accelerated.

The amount of the solvent in the suspension, which is obtained by combining dicamba and the co-crystal former B in the suitable solvent, is between 5% and 50% (w/w), preferably between 5% and 30% (w/w), based on the total weight of the thus obtained suspension.

The suspension may contain dicamba and the co-crystal former B in a relative molar ratio varying from 1:5 to 20:1, preferably from 1:1.2 to 15:1. If one of the components is in excess with regard to the stoichiometry of the co-crystal, a mixture of the co-crystal and the compound being in excess will be obtained. For formulation purposes, the presence of an excess of dicamba or the co-crystal former B might be acceptable. In particular the presence of an excess of dicamba does not cause stability problems. However, it is preferred, that the molar excess of the co-crystal former B in the aqueous suspension is not more than 20 mol %, in particular not more than 10 mol %, in comparison to the amount of dicamba present in the mixture. Therefore, the present invention relates in particular to aqueous formulations comprising the co-crystal of the present invention, provided that, if one or both of dicamba and the co-crystal former B are present in the formulation in non-complexed form, the amount of the non-complexed co-crystal former B does not exceed 20 mol-%, in particular 10 mol-% in the formulation.

The time required for formation of the co-crystal depends on the applied shear and the temperature and can be determined by the person skilled in the art in standard experiments. Times in the range of e.g. from 10 min. to 48 hours have been found to be suitable for formation of the co-crystal in the aqueous suspension containing dicamba and the co-crystal former B, although a longer period of time is also conceivable. A shearing time of 0.5 to 24 hours is preferred.

In a preferred embodiment, shear forces are applied to the aqueous suspension of the co-crystal former B and dicamba, which is obtained by combining dicamba and the co-crystal former B in the aqueous liquid. Shear forces can be applied by suitable techniques, which are capable of providing sufficient shear to bring the particles of dicamba and the co-crystal former B into an intimate contact and/or to comminute the particles of the co-crystal. Suitable techniques include grinding, crushing or milling, in particular by wet grinding or wet milling, including e.g. bead milling or by use of a colloid mill. Suitable shearing devices include in particular ball mills or bead mills, agitator ball mills, circulating mills (agitator ball mills with pin grinding system), disk mills, annular chamber mills, double cone mills, triple roll mills, batch mills, colloid mills, and media mills, such as sand mills. To dissipate the heat energy introduced during the grinding process, the grinding chambers are preferably fitted with cooling systems. Particularly suitable is the ball mill Drais Superflow DCP SF 12 from DRAISWERKE, INC.40 Whitney Road. Mahwah, N.J. 07430 USA, a Drais Perl Mill PMC from DRAISWERKE, INC., the circulating mill system ZETA from Netzsch-Feinmahltechnik GmbH, the disk mill from Netzsch Feinmahltechnik GmbH, Selb, Germany, the bead mill Eiger Mini 50 from Eiger Machinery, Inc., 888 East Belvidere Rd., Grayslake, Ill. 60030 USA and the bead mill DYNO-Mill KDL from WA Bachofen AG, Switzerland. However, other homogenizers might also be suitable, including high shear stirrers, Ultra-Turrax apparatus, static mixers, e.g. systems having mixing nozzles and other homogenizers such as colloid mills.

In a preferred embodiment of the invention, shear forces are applied by bead milling. In particular, bead sizes in the range of from 0.05 to 5 mm, more particularly from 0.2 to 2.5 mm, and most particularly from 0.5 to 1.5 mm have been found to be suitable. In general, bead loadings in the range of from 40 to 99%, particularly from 70 to 97%, and more particularly from 65 to 95% may be used.

Preferred solvents for the Shear process are polar organic solvents or mixtures of water and at least one polar organic solvent for the slurry process are those, which are at least partially water miscible, i.e. which have miscibility with water of at least 10% v/v, more preferably at least 20% v/v at room temperature, mixtures thereof and mixtures of said water miscible solvents with organic solvents that have miscibility with water of less than 10% v/v at room temperature. Preferably the organic solvent comprises at least 80% v/v, based on the total amount of organic solvent, of the at least one water miscible solvent.

Suitable solvents having a water miscibility of at least 10% at room temperature include, but are not limited to the polar organic solvents as defined above.

More preference is given to organic solvents of the group 1, and to their mixtures with water. In the mixtures with water the relative amount of organic solvent and water may vary from 200:1 to 1:200 (v/v), in particular from 1:5 to 1:100 (v/v).

An especially suitable polar organic solvent to be used alone or in mixture with water is an alcohol as mentioned above (C₁-C₄-alkanols such as methanol, ethanol, n-propanol or isopropanol).

c) In the Slurry process, the co-crystal is obtained from a slurry of dicamba and the co-crystal former B in a solvent comprising an organic solvent or in particular from a slurry of dicamba and the co-crystal former B in a mixture of water and organic solvent. Consequently, this method comprises suspending dicamba and the co-crystal former B in an organic solvent or in a mixture of water and organic solvent.

Preferred organic solvents or mixtures of water and organic solvent for the slurry process are those, where dicamba and the co-crystal former B have a comparable solubility. Comparable solubility means that the solubilities of the individual compounds in the solvent or solvent system differ by a factor of not more than 20, in particular by a factor of not more than 10. It is, however, also possible to use a solvent or solvent system, wherein the solubilities of the individual compounds are not comparable. In this case, it might be preferable to use the compound having the higher solubility in the respective solvent or solvent system in excess.

Preferred solvents for the slurry process are those, which are at least partially water miscible, i.e. which have miscibility with water of at least 10% v/v, more preferably at least 20% v/v at room temperature, mixtures thereof and mixtures of said water miscible solvents with organic solvents that have miscibility with water of less than 10% v/v at room temperature. Preferably the organic solvent comprises at least 80% v/v, based on the total amount of organic solvent, of the at least one water miscible solvent.

Suitable solvents are polar organic solvents as defined above.

More preference is given to organic solvents of the group 1, and to their mixtures with water. In the mixtures with water the relative amount of organic solvent and water may vary from 200:1 to 1:200 (v/v), in particular from 1:5 to 1:100 (v/v).

An especially suitable organic solvent to be used alone or in mixture with water is an alcohol as mentioned above (C₁-C₄-alkanols such as methanol, ethanol, n-propanol or isopropanol).

The slurry process can by simply performed by suspending dicamba and the co-crystal former B in the organic solvent or in a solvent/water mixture. The relative amounts of dicamba and the co-crystal former B and solvent or solvent/water mixture will be chosen to obtain a suspension at the given temperature. Complete dissolution of dicamba and the co-crystal former B should be avoided. In particular, dicamba and the co-crystal former B are suspended in an amount from 1 g to 500 g, more preferably 10 g to 400 g per litre of solvent or solvent/water mixture.

The relative molar amount of dicamba and the co-crystal former B in the slurry process may vary from 1:100 to 100:1, preferably from 1:10 to 10:1, depending on the relative solubilities of dicamba and the co-crystal former B in the chosen solvent or solvent system. In solvent systems where the solubilities of the pure dicamba and the co-crystal former B are comparable the preferred molar ratio is from 2:1 to 1:2, in particular from 1.5:1 to 1:1.5 and especially about 1:1 (i.e. from 1.1:1 to 1:1.1). An excess of co-crystal former B will be used in solvent systems where the co-crystal former B has a higher solubility. This applies also vice versa with dicamba. If one of the components is in excess with regard to the stoichiometry of the co-crystal, a mixture of the co-crystal and the compound being in excess might be obtained, though an excess might also remain dissolved in the mother liquor, in particular if the compound which is used in excess has a high solubility in the chosen solvent system. For formulation purposes, the presence of an excess of co-crystal former B or dicamba might be acceptable. In particular the presence of an excess of dicamba does not cause stability problems. For preparing the pure co-crystal, dicamba and the co-crystal former B will be used in a relative molar amount which is close to the stoichiometry of the co-crystal to be formed and which usually will not deviate more than 50 mol-%, based on the stoichiometrically required amount.

The slurry process is usually performed at a temperature of at least 5° C., preferably at least 10° C. and in particular at least 20° C., e.g. from 5 to 80° C., preferably from 10 to 55° C., in particular from 20 to 40° C.

The time required for formation of the co-crystal by the slurry process depends on the temperature, the type of solvent and is generally 1 h. In any case, complete conversion is achieved after one week; however, the complete conversion will usually require not more than 24 h.

According to one embodiment of the invention the slurry process is performed in the presence of co-crystals of dicamba and the co-crystal former B as seeding crystals. Usually 0.01% to 10% by weight, preferably 0.1% to 5% and more preferably 0.3% to 2% by weight of seeding crystals are employed based on the combined weight of dicamba and the co-crystal former B.

As already mentioned above, the co-crystal as defined herein are suitable for preparing crop protection compositions, such as aqueous suspension concentrates (SC, FS), suspo-emulsions (SE) and water dispersable granules (WG), water-dispersible powders (WP, WS), dustable powders (DP, DS), granules (GR, FG, GG, MG), dispersible concentrates (DC) and in particular for preparing a SC, FS, SE or WG formulation.

Accordingly, the invention also provides an agrochemical composition for crop protection, comprising co-crystals according to the present invention, in particular Complex I, Complex II, Complex III, Complex IV, Complex V, Complex VI, Complex VII or Complex VIIII as defined herein, and if appropriate, further customary formulation auxiliaries.

The term formulation auxiliaries includes, but is not limited to liquid and solid carriers and further auxiliaries such as surfactants (adjuvants, wetters, tackifiers, dispersants or emulsifiers), furthermore viscosity-modifying additives (thickeners), antifoam agents, antifreeze agents, agents for adjusting the pH, stabilizers, anticaking agents and biocides (preservatives). Further auxiliaries suitable for seed treatment formulations comprise colorants, stickers, fillers, and plasticizers.

The weight ratios of formulation auxiliaries and the respective co-crystal lie in ranges typically used for the respective solid formulation and the SE or SC formulation.

For example, in SCs and SEs, the amount of the co-crystal and, if appropriate, further active compounds is usually in the range from 10% to 70% by weight, in particular in the range from 15% to 50% by weight, based on the total weight of the suspension concentrate or suspo-emulsion.

In the other solid formulations (WG, WP, WS, DP, DS, GR, FG, GG, MG, DC), the amount of the co-crystal and, if appropriate, further active compounds is usually in the range from 10% to 90% by weight, in particular in the range from 15% to 70% by weight, based on the total weight of the solid formulation.

The total amount of formulation auxiliaries depends on the type of formulation used. Generally, it varies from 10% to 90% by weight, in particular from 85% to 30% by weight based on the total weight of the formulation.

The amount of surfactants varies depending on the formulation type. Usually, it is in the range from 0.1% to 20% by weight, in particular from 0.2% to 15% by weight and particularly preferably from 0.5% to 10% by weight based on the total weight of the formulation.

The amount of carriers (liquid or solid) varies depending on the formulation type. Usually, it is in the range from 1% to 90% by weight, in particular from 10 to 60% by weight and particularly preferably from 15% to 50% by weight based on the total weight of the formulation.

The amount of the remaining formulation auxiliaries (viscosity-modifying additives (thickeners), antifoam agents, antifreeze agents, agents for adjusting the pH, stabilizers, anticaking agents and biocides (preservatives), colorants, stickers, fillers, and plasticizers) varies depending on the formulation type. Usually, it is in the range from 0.1% to 60% by weight, in particular from 0. 5% to 40% by weight and particularly preferably from 1% to 20% by weight based on the total weight of the formulation.

Suitable liquid carriers are water, optionally containing water-miscible organic solvents, such as those of groups 1 to 10, and also organic solvents in which the co-crystals, in particular Complex I, Complex II, Complex III, Complex IV, Complex V, Complex VI, Complex VII or Complex VIII, have low or no solubility, for example those in which the solubility of the co-crystals, and in particular of Complex I, Complex II, Complex III, Complex IV, Complex VI Complex VII or Complex VIII are not more than 1% by weight at 25° C. and 1013 mbar, in particular not more than 0.5% by weight and especially not more than 0.1% by weight.

Examples of solvents (particularly useful for SE formulations) are organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, terpenes (including, but not limited to d-limonene) alkylated naphthalenes or their derivatives, linear and branched alcohols such as propanol, butanol, cyclohexanol, 2-phenoxyethanol, dodecylphenol, benzylalkohol, glycols, ketones such as cyclohexanone, 2-heptanone, acetophenone, 4-methoxyacetophenone, methylisoamylketone, methylisobutylketone, fatty acid dimethylamides, fatty acids and fatty acid esters, esters such as 2-ethylhexyl acetate, butylene carbonate, isobornyl acetate, dimethyl succinate, dimethyl adipate, dimethyl glutarate, diisobutyl succinate, diisobutyl adipate, diisobutyl glutarate (and also mixtures of esters, e.g. mixtures of dimethyl succinate, dimethyl adipate, dimethyl glutarate, e.g. commercially available as Rhodiasolv RPDE; or mixtures of diisobutyl succinate, diisobutyl adipate, diisobutyl glutarate e.g. commercially available as Rhodiasolv RPDE Rhodiasolv DIB), and strongly polar solvents, e.g. amines such as N-octylpyrrolidon and mixtures thereof.

Suitable solid carriers are, in principle, all solid substances usually used in crop protection compositions, in particular in fungicides. Solid carriers are, for example, mineral earths, such as silica gels, silicates, talc, kaolin, attaclay, limestone, lime, chalk, bole, loess, clay, dolomite, diatomaceous earth, calcium sulfate and magnesium sulfate, magnesium oxide, ground synthetic materials, fertilizers, such as, for example, ammonium sulfate, ammonium phosphate, ammonium nitrate, ureas and products of vegetable origin, such as cereal meal, tree bark meal, wood meal and nutshell meal, cellulose powders and other solid carriers.

Preferred surfactants are anionic and non-ionic surfactants (emulsifiers). Suitable surfactants are also protective colloids.

Suitable surfactants (adjuvants, wetters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalenesulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributyiphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e.g. methylcellulose), hydrophobically modified starches, polyvinyl alcohols (Mowiol® types, Clariant, Switzerland), polycarboxylates (Sokalan® types, BASF, Germany), polyalkoxylates, polyvinylamines (Lupasol® types, BASF, Germany), polyvinylpyrrolidone and the copolymers thereof.

Viscosity-modifying additives (thickeners) are compounds that impart a modified flowability to compositions, i.e. high viscosity under static conditions and low viscosity during agitation). Examples of suitable thickeners are polysaccharides and organic and inorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA). (added at 0.005%-10%, 0.01%-5%, or 0.02%-2%)

Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof.

Preservatives (bactericides) may be added for stabilizing the suspension concentrates according to the invention. Suitable preservatives are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Suitable antifreeze agents are liquid polyols, for example ethylene glycol, propylene glycol or glycerol.

If appropriate, the water dispersable granules (WG), water-dispersible powders (WP, WS), dustable powders (DP, DS), granules (GR, FG, GG, MG), Dispersible concentrates (DC), in particular in the WG, SCs or SEs according to the invention may comprise buffers for regulating the pH. Examples of buffers are alkali metal salts of weak inorganic or organic acids, such as, for example, phosphoric acid, boric acid, acetic acid, propionic acid, citric acid, fumaric acid, tartaric acid, oxalic acid and succinic acid.

If the formulations of the co-crystals are used for seed treatment, they may comprise further customary components as employed in the seed treatment, e.g. in dressing or coating. Examples are in particular colorants, stickers, fillers, and plasticizers besides the above-mentioned components.

Colorants are all dyes and pigments which are customary for such purposes. In this context, both pigments, which are sparingly soluble in water, and dyes, which are soluble in water, may be used. Examples which may be mentioned are the dyes and pigments known under the names Rhodamin B, C. I. Pigment Red 112 and C. I. Solvent Red 1, Pigment blue 15:4, Pigment blue 15:3, Pigment blue 15:2, Pigment blue 15:1, Pigment blue 80, Pigment yellow 1, Pigment yellow 13, Pigment red 48:2, Pigment red 48:1, Pigment red 57:1, Pigment red 53:1, Pigment orange 43, Pigment orange 34, Pigment orange 5, Pigment green 36, Pigment green 7, Pigment white 6, Pigment brown 25, Basic violet 10, Basic violet 49, Acid red 51, Acid red 52, Acid red 14, Acid blue 9, Acid yellow 23, Basic red 10, Basic red 108. The amount of colorants will usually not exceed 20% by weight of the formulation and preferably ranges from 0.1% to 15% by weight, based on the total weight of the formulation.

Stickers are all customary binders which can be employed in dressing products. Examples of suitable binders comprise thermoplastic polymers such as polyvinylpyrrolidone, polyvinyl acetate, polyvinyl alcohol and tylose, furthermore polyacrylates, polymethacrylates, polybutenes, polyisobutenes, polystyrene, polyethylenamines, polyethylenamides, the aforementioned protective colloids, polyesters, polyetheresters, polyanhydrides, polyesterurethanes, polyesteramides, thermoplastic polysaccharides, e.g. cellulose derivates such as celluloseesters, celluloseethers, celluloseetheresters including methylcellulose, ethylcellullose, hydroxymethylcellulose, carboxymethylcellulose, hydroxypropylcellulose and starch derivatives and modified starches, dextrines, maltodextrines, alginates and chitosanes, moreover fats, oils, proteins, including casein, gelatin and zeins, gum arabics, shellacs. Preferred stickers are biocompatible, i.e. they do not have a noticeable phytotoxic activity. Preferably the stickers are biodegradable. Preferably the sticker is chosen that it acts as a matrix for the active ingredients of the formulation. The amount of stickers will usually not exceed 40% by weight of the formulation and preferably ranges from 1% to 40% by weight, and in particular in the range from 5% to 30% by weight, based on the total weight of the formulation.

In general, the respective solid formulations, in particular the SC, SE or WG comprise the co-crystal in a finely divided particulate form. In SC- and SE-formulations the particles of the co-crystal are suspended in a liquid medium, preferably in an aqueous medium. In water dispersable granules (WG), water-dispersible powders (WP, WS), Dustable powders (DP, DS), granules (GR, FG, GG, MG), Dispersible concentrates (DC), in particular in the WG, the finely divided particles are loosely agglomerated into larger granules that disintegrate upon dilution in water and then lead to a suspension of these finely divided particles. The size of the active compound particles, i.e. the size which is not exceeded by 90% by weight of the active compound particles, is typically not more than 30 μm, preferably not more than 20 μm, in particular not more than 10 μm, especially not more than 5 μm, as determined by dynamic light scattering. Advantageously, at least 40% by weight and in particular at least 60% by weight of the particles in the SCs according to the invention have diameters below 2 μm.

The respective formulations can be prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

For example, suspension concentrates, in particular aqueous suspension concentrates can be prepared by suspending the co-crystal in a suitable liquid carrier, which may contain conventional formulation additives as described hereinafter. However, it is preferred to prepare the suspension concentrate by the shear process as described herein, i.e. by applying shear forces to a liquid which contains suspended particles of dicamba and caffeine and optionally further additives until the co-crystal has been formed.

Suspo-emulsions can be prepared in accordance with the methods as described for SCs with the proviso that a second pesticide (besides the co-crystal) can be added to the final SC or during preparation of the SC solubilised in a suitable organic solvent (optionally together with suitable further formulation auxiliaries).

Powders, materials for spreading and dustable products can be prepared by mixing or concomitantly grinding the co-crystal (and optionally a further pesticide) with a solid carrier.

Granules, for example coated granules, impregnated granules and homogeneous granules, can be prepared by binding the active compounds to solid carriers.

Powders, materials for spreading and dusts can be prepared by mixing or concomitantly grinding the compounds I and, if appropriate, further active substances, with at least one solid carrier.

Granules, e.g. coated granules, impregnated granules and homogeneous granules, can be prepared by binding the active substances to solid carriers.

The formulations as described above may also comprise further active compounds against pests. For example, insecticides or further herbicides or fungicides or else herbicidal or growth-regulating active compounds or fertilizers can be added as further active components according to need.

All embodiments of the formulations comprising at least one co-crystal are herein below referred to as “agrochemical formulation”.

It may also be advantageous to use the co-crystals according to the invention in combination with safeners. Safeners are chemical compounds which prevent or reduce damage to useful plants without substantially affecting the herbicidal action of the co-crystals on unwanted plants. They can be used both before sowing (for example in the treatment of seed, or on cuttings or seedlings) and before or after the emergence of the useful plant. The safeners and the co-crystals can be used simultaneously or in succession. Suitable safeners are, for example, (quinolin-8-oxy)acetic acids, 1-phenyl-5-haloalkyl-1H-1,2,4-triazole-3-carboxylic acids, 1-phenyl-4,5-dihydro-5-alkyl-1H-pyr azole-3,5-dicarboxylic acids, 4,5-dihydro-5,5-diary)-3-isoxazolecarboxylic acids, dichloroacetamides, alpha-oximinophenylacetonitriles, acetophenone oximes, 4,6-dihalo-2-phenylpyrimidines, N-[[4-(aminocarbonyl)phenyl]sulfonyl]-2-benzamides, 1,8-naphthalic anhydride, 2-halo-4-(haloalkyl)-5-thiazolecarboxylic acids, phosphorothiolates and O-phenyl N-alkylcarbamates and their agriculturally useful salts and, provided that they have an acid function, their agriculturally useful derivatives, such as amides, esters and thioesters.

To broaden the activity spectrum and to obtain synergistic effects, the co-crystals according to the invention can be mixed and jointly applied with numerous representatives of other herbicidal or growth-regulating groups of active compounds or with safeners. Suitable mixing partners are, for example, 1,2,4-thiadiazoles, 1,3,4-thiadiazoles, amides, aminophosphoric acid and its derivatives, aminotriazoles, anilides, aryloxy/heteroaryloxyalkanoic acids and their derivatives, benzoic acid and its derivatives, benzothiadiazinones, 2-(hetaroyl/aroyl)-1,3-cyclohexanediones, heteroaryl aryl ketones, benzylisoxazolidinones, meta-CF₃-phenyl derivatives, carbamates, quinoline carboxylic acid and its derivatives, chloroacetanilides, cyclohexenone oxime ether derivates, diazines, dichloropropionic acid and its derivatives, dihydrobenzofurans, dihydrofuran-3-ones, dinitroanilines, dinitrophenols, diphenyl ethers, dipyridyls, halocarboxylic acids and their derivatives, ureas, 3-phenyluracils, imidazoles, imidazolinones, N-phenyl-3,4,5,6-tetrahydrophthalimides, oxadiazoles, oxiranes, phenols, aryloxy- and heteroaryloxyphenoxypropionic esters, phenylacetic acid and its derivatives, 2-phenylpropionic acid and its derivatives, pyrazoles, phenylpyrazoles, pyridazines, pyridinecarboxylic acid and its derivatives, pyrimidyl ethers, sulfonamides, sulfonylureas, triazines, triazinones, triazolinones, triazolecarboxamides, uracils and also phenylpyrazolines and isoxazolines and their derivatives.

Moreover, it may be useful to apply the co-crystals alone or in combination with other herbicides or else also mixed with further crop protection agents, jointly, for example with compositions for controlling pests or phytopathogenic fungi or bacteria. Also of interest is the miscibility with mineral salt solutions which are employed for alleviating nutritional and trace element deficiencies. Other additives such as nonphytotoxic oils and oil concentrates may also be added.

Examples of herbicides C), which can be used in combination with the co-crystals according to the present invention, are:
c1) from the group of the lipid biosynthesis inhibitors:
alloxydim, alloxydim-sodium, butroxydim, clethodim, clodinafop, clodinafoppropargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-Pmethyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim, benfuresate, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate and vernolate;
c2) from the group of the ALS inhibitors:
amidosulfuron, azimsulfuron, bensulfuron, bensulfuron-methyl, bispyribac, bispyribac-sodium, chlorimuron, chlorimuron-ethyl, chlorsulfuron, cinosulfuron, cloransulam, cloransulam-methyl, cyclosulfamuron, diclosulam, ethametsulfuron, ethametsulfuron-methyl, ethoxysulfuron, flazasulfuron, florasulam, flucarbazone, flucarbazonesodium, flucetosulfuron, flumetsulam, flupyrsulfuron, flupyrsulfuron-methyl-sodium, foramsulfuron, halosulfuron, halosulfuron-methyl, imazamethabenz, imazamethabenzmethyl, imazamox, imazapic, imazapyr, imazaquin, imazethapyr, imazosulfuron, iodosulfuron, iodosulfuron-methyl-sodium, mesosulfuron, metosulam, metsulfuron, metsulfuron-methyl, nicosulfuron, orthosulfamuron, oxasulfuron, penoxsulam, primisulfuron, primisulfuron-methyl, propoxycarbazone, propoxycarbazone-sodium, prosulfuron, pyrazosulfuron, pyrazosulfuron-ethyl, pyribenzoxim, pyrimisulfan, pyriftalid, pyriminobac, pyriminobac-methyl, pyrithiobac, pyrithiobac-sodium, pyroxsulam, rimsulfuron, sulfometuron, sulfometuron-methyl, sulfosulfuron, thiencarbazone, thiencarbazonemethyl, thifensulfuron, thifensulfuron-methyl, triasulfuron, tribenuron, tribenuron-methyl, trifloxysulfuron, triflusulfuron, triflusulfuron-methyl and tritosulfuron;
c3) from the group of the photosynthesis inhibitors:
ametryn, amicarbazone, atrazine, bentazone, bentazone-sodium, bromacil, bromofenoxim, bromoxynil and its salts and esters, chlorobromuron, chloridazone, chlorotoluron, chloroxuron, cyanazine, desmedipham, desmetryn, dimefuron, dimethametryn, diquat, diquat-dibromide, diuron, fluometuron, hexazinone, ioxynil and its salts and esters, isoproturon, isouron, karbutilate, lenacil, linuron, metamitron, methabenzthiazuron, metobenzuron, metoxuron, metribuzin, monolinuron, neburon, paraquat, paraquatdichloride, paraquat-dimetilsulfate, pentanochlor, phenmedipham, phenmediphamethyl, prometon, prometryn, propanil, propazine, pyridafol, pyridate, siduron, simazine, simetryn, tebuthiuron, terbacil, terbumeton, terbuthylazine, terbutryn, thidiazuron and trietazine;
c4) from the group of the protoporphyrinogen-IX oxidase inhibitors:
acifluorfen, acifluorfen-sodium, azafenidin, bencarbazone, benzfendizone, bifenox, butafenacil, carfentrazone, carfentrazone-ethyl, chlomethoxyfen, cinidon-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, 2-chloro-5-[3,6-dihydro-3-methyl-2,6-dioxo-4-(trifluoromethyl)-1(2H)-pyrimidinyl]-4-fluoro-N-[(isopropyl)methylsulfamoyl]benzamide (H-1; CAS 372137-35-4), ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (H-2; CAS 353292-31-6), N-ethyl-3-(2,6-dichloro-4-trifluoromethylphenoxy)-5-methyl-1H-pyrazole-1-carboxamide (H-3; CAS 452098-92-9), N-tetrahydrofurfuryl-3-(2,6-dichloro-4-trifluoromethylphenoxy)-5-methyl-1H-pyrazole-1-carboxamide (H-4; CAS 915396-43-9), N-ethyl-3-(2-chloro-6-fluoro-4-trifluoromethylphenoxy)-5-methyl-1H-pyrazole-1-carboxamide (H-5; CAS 452099-05-7), N-tetrahydrofurfuryl-3-(2-chloro-6-fluoro-4-trifluoromethylphenoxy)-5-methyl-1H-pyrazole-1-carboxamide (H-6; CAS 45100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione, 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione and 1-Methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione;
c5) from the group of the bleacher herbicides:
aclonifen, amitrol, beflubutamid, benzobicyclon, benzofenap, clomazone, diflufenican, fluridone, flurochloridone, flurtamone, isoxaflutole, mesotrione, norflurazon, picolinafen, pyrasulfutole, pyrazolynate, pyrazoxyfen, sulcotrione, tefuryltrione, ternbotrione, topramezone, 4-hydroxy-3-[[2-[(2-methoxyethoxy)methyl]-6-(trifluoromethyl)-3-pyridyl]carbonyl]bicyclo[3.2.1]oct-3-en-2-one (H-7; CAS 352010-68-5) and 4-(3-trifluoromethylphenoxy)-2-(4-trifluoromethylphenyl)pyrimidine (H-8; CAS 180608-33-7);
c6) from the group of the EPSP synthase inhibitors:
glyphosate, glyphosate-isopropylammonium and glyphosate-trimesium (sulfosate);
c7) from the group of the glutamine synthase inhibitors:
bilanaphos (bialaphos), bilanaphos-sodium, glufosinate and glufosinate-ammonium;
c8) from the group of the DHP synthase inhibitors:
asulam;
c9) from the group of the mitose inhibitors:
amiprophos, amiprophos-methyl, benfluralin, butamiphos, butralin, carbetamide, chlorpropham, chlorthal, chlorthal-dimethyl, dinitramine, dithiopyr, ethalfluralin, fluchloralin, oryzalin, pendimethalin, prodiamine, propham, propyzamide, tebutam, thiazopyr and trifluralin;
c10) from the group of the VLCFA inhibitors:
acetochlor, alachlor, anilofos, butachlor, cafenstrole, dimethachlor, dimethanamid, dimethenamid-P, diphenamid, fentrazamide, flufenacet, mefenacet, metazachlor, metolachlor, metolachlor-S, naproanilide, napropamide, pethoxamid, piperophos, pretilachlor, propachlor, propisochior, pyroxasulfone (KIH-485) and thenylchlor; Compounds of the formula 2:

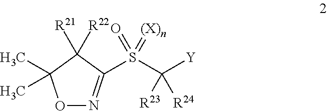

in which the variables have the following meanings:
Y is phenyl or 5- or 6-membered heteroaryl as defined at the outset, which radicals may be substituted by one to three groups R^{aa}; R²¹, R²², R²³, R²⁴ are H, halogen or C₁-C₄-alkyl; X is O or NH; N is 0 or 1.

Compounds of the formula 2 have in particular the following meanings:

Y is

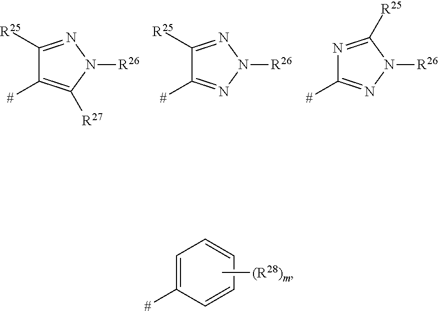

where # denotes the bond to the skeleton of the molecule; and R²¹, R²², R²³, R²⁴ are H, Cl, F or CH₃; R²⁵ is halogen, C₁-C₄-alkyl or C₁-C₄-haloalkyl; R²⁶ is C₁-C₄-alkyl; R²⁷ is halogen, C₁-C₄-alkoxy or C₁-C₄-haloalkoxy; R²⁸ is H, halogen, C₁-C₄-haloalkyl or C₁-C₄-haloalkoxy; M is 0, 1, 2 or 3; X is oxygen; N is 0 or 1.

Preferred compounds of the formula 2 have the following meanings:

Y is

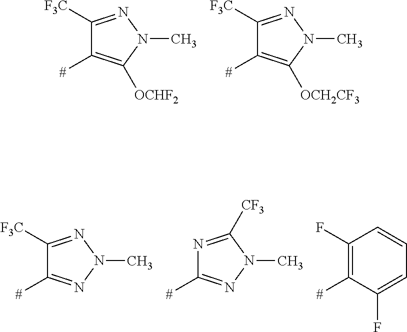

R²¹ is H; R²², R²³ are F; R²⁴ is H or F; X is oxygen; N is 0 or 1.

Particularly preferred compounds of the formula 2 are:

3-[5-(2,2-difluoroethoxy)-1-methyl-3-trifluoromethyl-1H-pyrazol-4-ylmethane-sulfonyl]-4-fluoro-5,5-dimethyl-4,5-dihydroisoxazole (2-1); 3-{[5-(2,2-difluoroethoxy)-1-methyl-3-trifluoromethyl-1H-pyrazol-4-yl]fluoromethanesulfonyl}-5,5-dimethyl-4,5-dihydroisoxazole (2-2); 4-(4-fluoro-5,5-dimethyl-4,5-dihydroisoxazole-3-sulfonylmethyl)-2-methyl-5-trifluoromethyl-2H-[1,2,3]triazole (2-3); 4-[(5,5-dimethyl-4,5-dihydroisoxazole-3-sulfonyl)fluoromethyl]-2-methyl-5-trifluoromethyl-2H-[1,2,3]triazole (2-4); 4-(5,5-dimethyl-4,5-dihydroisoxazole-3-sulfonylmethyl)-2-methyl-5-trifluoromethyl-2H-[1,2,3]triazole (2-5); 3-{[5-(2,2-difluoroethoxy)-1-methyl-3-trifluoromethyl-1H-pyrazol-4-yl]difluoromethanesulfonyl}-5,5-dimethyl-4,5-dihydroisoxazole (2-6); 4-[(5,5-dimethyl-4,5-dihydroisoxazole-3-sulfonyl)difluoromethyl]-2-methyl-5-trifluoromethyl-2H-[1,2,3]triazole (2-7); 3-[5-(2,2-difluoroethoxy)-1-methyl-3-trifluoromethyl-1H-pyrazol-4-yl]difluoromethanesulfonyl}-4-fluoro-5,5-dimethyl-4,5-dihydroisoxazole (2-8); 4-[difluoro-(4-fluoro-5,5-dimethyl-4,5-dihydroisoxazole-3-sulfonyl)methyl]-2-methyl-5-trifluoromethyl-2H-[1,2,3]triazole (2-9);
c11) from the group of the cellulose biosynthesis inhibitors:
chlorthiamid, dichlobenil, flupoxam and isoxaben;
c12) from the group of the decoupler herbicides:
dinoseb, dinoterb and DNOC and its salts;
c13) from the group of the auxin herbicides:
2,4-D and its salts and esters, 2,4-DB and its salts and esters, aminopyralid and its salts such as aminopyralid-tris(2-hydroxypropyl)ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, fluroxypyr, fluroxypyr-butometyl, fluroxypyrmeptyl, MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters, triclopyr and its salts and esters, and 5,6-dichloro-2-cyclopropyl-4-pyrimidinecarboxylic acid (H-9; CAS 858956-08-8) and its salts and esters;
c14) from the group of the auxin transport inhibitors: diflufenzopyr, diflufenzopyrsodium, naptalam and naptalam-sodium;
c15) from the group of the other herbicides: bromobutide, chlorllurenol, chlorilurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-Mmethyl, flurenol, flurenol-butyl, flurprimidol, fosamine, fosamine-ammonium, indanofan, maleic hydrazide, mefluidide, metam, methyl azide, methyl bromide, methyl-dymron, methyl iodide, MSMA, oleic acid, oxaziclomefone, pelargonic acid, pyributicarb, quinoclamine, triaziflam, tridiphane and 6-chloro-3-(2-cyclopropyl-6-methylphenoxy)-4-pyridazinol (H-10; CAS 499223-49-3) and its salts and esters.

Examples of preferred safeners D are benoxacor, cloquintocet, cyometrinil, cyprosulfamide, dichlormid, dicyclonone, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane (H-11; MON4660, CAS 71526-07-3) and 2,2,5-trimethyl-3-(dichloroacetyl)-1,3-oxazolidine (H-12; R-29148, CAS 52836-31-4).

The active compounds of groups c1) to c15) and the safeners D are known herbicides and safeners, see, for example, The Compendium of Pesticide Common Names (http://www.alanwood.net/pesticides/); B. Hock, C. Fedtke, R. R. Schmidt, Herbizide [Herbicides], Georg Thieme Verlag, Stuttgart, 1995. Further herbicidally active compounds are known from WO 96/26202, WO 97/41116, WO 97/41117, WO 97/41118, WO 01/83459 and WO 2008/074991 and from W. Krämer et al. (ed.) “Modern Crop Protection Compounds”, Vol. 1, Wiley VCH, 2007 and the literature quoted therein.

In a preferred embodiment of the invention, the co-crystals according to the invention are mixed with at least one herbicide C) selected from the group consisting of
c6) from the group of the EPSP synthase inhibitors: glyphosate, glyphosate-isopropylammonium and glyphosate-trimesium (sulfosate);
c7) from the group of the glutamine synthase inhibitors: bilanaphos (bialaphos), bilanaphos-sodium, glufosinate and glufosinate-ammonium; including their agriculturally acceptable salts or derivatives;

In another preferred embodiment, B) is selected from the group consisting of
c6) glyphosate, glyphosate-isopropylammonium, glyposate-potassium and glyphosate-trimesium (sulfosate); and
c7) bilanaphos (bialaphos), bilanaphos-sodium, glufosinate, glufosinate-P, glufosinate-ammonium and glufosinate-P-ammonium
In another preferred embodiment, B) is selected from the group consisting of
   c6) glyphosate, glyphosate-isopropylammonium and glyphosate-trimesium (sulfosate); and
   c7) glufosinate, glufosinate-P, glufosinate-ammonium and glufosinate-P-ammonium;
In another preferred embodiment, B) is selected from the group consisting of glyphosate-isopropylammonium, glyphosate-trimesium (sulfosate), glufosinate-ammonium and glufosinate-P-ammonium;
In another preferred embodiment, B) is selected from the group consisting of glyphosate-isopropylammonium and glufosinate-ammonium.

Particularly preferred are the following combinations co-crystal+herbicide C):

| | co-crystal | herbicide C) |
|---|---|---|
| 1 | Complex I | glyphosate and its salts, in part. |
| | | glyphosate-acid |
| 2 | Complex II | glyphosate and its salts, in part. |
| | | glyphosate-acid |
| 3 | Complex III | glyphosate and its salts, in part. |
| | | glyphosate-acid |
| 4 | Complex IV | glyphosate and its salts, in part. |
| | | glyphosate-acid |
| 5 | Complex V | glyphosate and its salts, in part. |
| | | glyphosate-acid |
| 6 | Complex VI | glyphosate and its salts, in part. |
| | | glyphosate-acid |
| 7 | Complex VII | glyphosate and its salts, in part. |
| | | glyphosate-acid |
| 8 | Complex VIII | glyphosate and its salts, in part. |
| | | glyphosate-acid |
| 9 | Complex I | glyphosate-potassium |
| 10 | Complex II | glyphosate-potassium |
| 11 | Complex III | glyphosate-potassium |
| 12 | Complex IV | glyphosate-potassium |
| 13 | Complex V | glyphosate-potassium |
| 14 | Complex VI | glyphosate-potassium |
| 15 | Complex VII | glyphosate-potassium |
| 16 | Complex VIII | glyphosate-potassium |
| 17 | Complex I | glyphosate-isopropylammonium |
| 18 | Complex II | glyphosate-isopropylammonium |
| 19 | Complex III | glyphosate-isopropylammonium |
| 20 | Complex IV | glyphosate-isopropylammonium |
| 21 | Complex V | glyphosate-isopropylammonium |
| 22 | Complex VI | glyphosate-isopropylammonium |
| 23 | Complex VII | glyphosate-isopropylammonium |
| 24 | Complex VIII | glyphosate-isopropylammonium |
| 25 | Complex I | glufosinate-P and its salts, in part. |
| | | glufosinate-P-ammonium |
| 26 | Complex II | glufosinate-P and its salts, in part. |
| | | glufosinate-P-ammonium |
| 27 | Complex III | glufosinate-P and its salts, in part. |
| | | glufosinate-P-ammonium |
| 28 | Complex IV | glufosinate-P and its salts, in part. |
| | | glufosinate-P-ammonium |
| 29 | Complex V | glufosinate-P and its salts, in part. |
| | | glufosinate-P-ammonium |
| 30 | Complex VI | glufosinate-P and its salts, in part. |
| | | glufosinate-P-ammonium |
| 31 | Complex VII | glufosinate-P and its salts, in part. |
| | | glufosinate-P-ammonium |
| 32 | Complex VIII | glufosinate-P and its salts, in part. |
| | | glufosinate-P-ammonium |

The present invention furthermore relates to a method of controlling undesired vegetation, which comprises allowing a herbicidally effective amount of at least one co-crystal comprising dicamba and a co-former B or an agrochemical composition comprising said co-crystal to act on plants, or their habitat.

The term “undesired vegetation” (“weeds”) is understood to include any vegetation growing in non-crop-areas or at a crop plant site or locus of seeded and otherwise desired crop, where the vegetation is any plant species, including their germinant seeds, emerging seedlings and established vegetation, other than the seeded or desired crop (if any). Weeds, in the broadest sense, are plants considered undesirable in a particular location, for example:

Dicotyledonous weeds of the genera: Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus; Taraxacum.

Monocotyledonous weeds of the genera: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristyslis, Sagittaria, Eleocharis, Scirpus, Paspalum, Ischaemum, Sphenoclea, Dactyloctenium, Agrostis, Alopecurus, Apera.

Generally the term “plants” also includes plants which have been modified by breeding, mutagenesis or genetic engineering (transgenic and non-transgenic plants). Genetically modified plants are plants, which genetic material has been modified by the use of recombinant DNA techniques in a way that it cannot readily be obtained by cross breeding under natural circumstances, mutations or natural recombination.

Plants and as well as the propagation material of said plants, which can be treated with the co-crystals, in particular Complex I, Complex II, Complex III, Complex IV, Complex V, Complex VI, Complex VII or Complex VIII, include all modified non-transgenic plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

For example, the co-crystals, in particular Complex I, Complex II, Complex III, Complex IV, Complex V, Complex VI, Complex VII or Complex VIII, can be applied in accordance with the methods of treatment as set forth above also to plants which have been modified by breeding, mutagenesis or genetic engineering including but not limiting to agrochemical biotech products on the market or in development (cf. http://www.bio.org/speeches/pubs/er/agri_products.asp). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transitional modification of protein(s), oligo- or polypeptides e.g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides. Tolerance to herbicides can be obtained by creating insensitivity at the site of action of the herbicide by expression of a target enzyme which is resistant to herbicide; rapid metabolism (conjugation or degradation) of the herbicide by expression of enzymes which inactivate herbicide; or poor uptake and translocation of the herbicide. Examples are the expression of enzymes which are tolerant to the herbicide in comparison to wild type enzymes, such as the expression of 5-enolpyruvylshikimate-3-phosphate synthase (EPSPS), which is tolerant to glyphosate (see e.g. Heck et. al, Crop Sci. 45, 2005, 329-339; Funke et. al, PNAS 103, 2006, 13010-13015; U.S. Pat. No. 5,188,642, U.S. Pat. No. 4,940,835, U.S. Pat. No. 5,633,435, U.S. Pat. No. 5,804,425, U.S. Pat. No. 5,627,061), the expression of glutamine synthase which is tolerant to glufosinate and bialaphos (see e.g. U.S. Pat. No. 5,646,024, U.S. Pat. No. 5,561,236) and DNA constructs coding for dicamba-degrading enzymes (see for general reference US 2009/0105077, e.g. U.S. Pat. No. 7,105,724 for dicamba resistance in bean, maize (for maize see also WO2008051633), cotton (for cotton see also U.S. Pat. No. 5,670,454), pea, potato, sorghum, soybean (for soybean see also U.S. Pat. No. 5,670,454), sunflower, tobacco, tomato (for tomato see also U.S. Pat. No. 5,670,454)).

Furthermore, this comprises also plants tolerant to applications of imidazolinone herbicides (canola (Tan et. al, Pest Manag. Sci 61, 246-257 (2005)); maize (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100, Tan et. al, Pest Manag. Sci 61, 246-257 (2005)); rice (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100, S653N (see e.g. US 2003/0217381), S654K (see e.g. US 2003/0217381), A122T (see e.g. WO 04/106529) S653 (At)N, S654 (At)K, A122 (At)T and other resistant rice plants as described in WO0027182, WO 05/20673 and WO0185970 or US patents U.S. Pat. No. 5,545,822, U.S. Pat. No. 5,736,629, U.S. Pat. No. 5,773,703, U.S. Pat. No. 5,773,704, U.S. Pat. No. 5,952,553, U.S. Pat. No. 6,274,796); millet (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100); barley (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100); wheat (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439, U.S. Pat. No. 6,222,100, WO 04/106529, WO 04/16073, WO 03/14357, WO 03/13225 and WO 03/14356); sorghum (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100); oats (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100); rye (U.S. Pat. No. 4,761,373, U.S. Pat. No. 5,304,732, U.S. Pat. No. 5,331,107, U.S. Pat. No. 5,718,079, U.S. Pat. No. 6,211,438, U.S. Pat. No. 6,211,439 and U.S. Pat. No. 6,222,100); sugar beet (WO9802526/WO9802527); lentils (US2004/0187178); sunflowers (Tan et. al, Pest Manag. Sci 61, 246-257 (2005))). Gene constructs can be obtained, for example, from micro-organism or plants, which are tolerant to said herbicides, such as the Agrobacterium strain CP4 EPSPS which is resistant to glyphosate; Streptomyces bacteria which are resistance to glufosinate; Arabidopsis, Daucus carotte, Pseudomonoas sp. or Zea mais with chimeric gene sequences coging for HDDP (see e.g. W01996/38567, WO 2004/55191); Arabidopsis thaliana which is resistant to protox inhibitors (see e.g. US2002/0073443).

Examples of commercial available plants with tolerance to herbicides, are the corn varieties “Roundup Ready Corn”, “Roundup Ready 2” (Monsanto), “Agrisure GT”, “Agrisure GT/CB/LL”, “Agrisure GT/RW”, “Agrisure 3000GT” (Syngenta), “YieldGard VT Rootworm/RR2” and “YieldGard VT Triple” (Monsanto) with tolerance to glyphosate; the corn varieties “Liberty Link” (Bayer), “Herculex I”, “Herculex RW”, “Herculex Xtra” (Dow, Pioneer), “Agrisure GT/CB/LL” and “Agrisure CB/LL/RW” (Syngenta) with tolerance to glufosinate; the soybean varieties “Roundup Ready Soybean” (Monsanto) and “Optimum GAT” (DuPont, Pioneer) with tolerance to glyphosate; the cotton varieties “Roundup Ready Cotton” and “Roundup Ready Flex” (Monsanto) with tolerance to glyphosate; the cotton variety “FiberMax Liberty Link” (Bayer) with tolerance to glufosinate; the cotton variety “BXN” (Calgene) with tolerance to bromoxynil; the canola varieties “Navigator” and “Compass” (Rhone-Poulenc) with bromoxynil tolerance; the canola variety“Roundup Ready Canola” (Monsanto) with glyphosate tolerance; the canola variety “InVigor” (Bayer) with glufosinate tolerance; the rice variety “Liberty Link Rice” (Bayer) with glulfosinate tolerance and the alfalfa variety “Roundup Ready Alfalfa” with glyphosate tolerance. Further modified plants with herbicide are commonly known, for instance alfalfa, apple, eucalyptus, flax, grape, lentils, oil seed rape, peas, potato, rice, sugar beet, sunflower, tobacco, tomatom turf grass and wheat with tolerance to glyphosate (see e.g. U.S. Pat. No. 5,188,642, U.S. Pat. No. 4,940,835, U.S. Pat. No. 5,633,435, U.S. Pat. No. 5,804,425, U.S. Pat. No. 5,627,061); beans, soybean, cotton, peas, potato, sunflower, tomato, tobacco, corn, sorghum and sugarcane with tolerance to dicamba (see e.g. US 2009/0105077, U.S. Pat. No. 7,105,724 and U.S. Pat. No. 5,670,454); pepper, apple, tomato, hirse, sunflower, tobacco, potato, corn, cucumber, wheat, soybean and sorghum with tolerance to 2,4-D (see e.g. U.S. Pat. No. 6,153,401, U.S. Pat. No. 6,100,446, WO2005107437, U.S. Pat. No. 5,608,147 and U.S. Pat. No. 5,670,454); sugarbeet, potato, tomato and tobacco with tolerance to gluphosinate (see e.g. U.S. Pat. No. 5,646,024, U.S. Pat. No. 5,561,236); canola, barley, cotton, juncea, lettuce, lentils, melon, millet, oats, oilseed rapre, potato, rice, rye, sorghum, soybean, sugarbeet, sunflower, tobacco, tomato and wheat with tolerance to acetolactate synthase (ALS) inhibiting herbicides, such as triazolopyrimidine sulfonamides, growth inhibitors and imidazolinones (see e.g. U.S. Pat. No. 5,013,659, WO2006060634, U.S. Pat. No. 4,761,373, U.S. Pat. No. 5,304,732, U.S. Pat. No. 6,211,438, U.S. Pat. No. 6,211,439 and U.S. Pat. No. 6,222,100); cereal, sugar cane, rice, corn, tobacco, soybean, cotton, rapeseed, sugar beet and potato with tolerance to HPPD inhibitor herbicides (see e.g. WO2004/055191, WO199638567, WO1997049816 and U.S. Pat. No. 6,791,014); wheat, soybean, cotton, sugar beet, rape, rice, corn, sorghum and sugar cane with tolerance to protoporphyrinogen oxidase (PPO) inhibitor herbicides (see e.g. US2002/0073443, US20080052798, Pest Management Science, 61, 2005, 277-285). The methods of producing such herbicide resistant plants are generally known to the person skilled in the art and are described, for example, in the publications mentioned above.

Further examples of commercial available modified plants with tolerance to herbicides “CLEARFIELD Corn”, “CLEARFIELD Canola”, “CLEARFIELD Rice”, “CLEARFIELD Lentils”, “CLEARFIELD Sunlowers” (BASF) with tolerance to the imidazolinone herbicides.

Furthermore, plants are also covered that are by the use of recombinant DNA techniques capable to synthesize one or more insecticidal proteins, especially those known from the bacterial genus Bacillus, particularly from Bacillus thuringiensis, such as 6-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are disclosed, e.g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the CryIAb toxin), YieldGard® Plus (corn cultivars producing CryIAb and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN© 33B (cotton cultivars producing the CryIAc toxin), Bollgard® I (cotton cultivars producing the CryIAc toxin), Bollgard® II (cotton cultivars producing CryIAc and Cry2Ab2 toxins); VIPCOT® (cotton cultivars producing a VIP-toxin); NewLeaf® (potato cultivars producing the Cry3A toxin); BtXtra®, NatureGard®, KnockOut®, BiteGard®, Protecta®, Bt11 (e.g. Agrisure® CB) and Bt176 from Syngenta Seeds SAS, France, (corn cultivars producing the CryIAb toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP-A 392 225), plant disease resistance genes (e.g. potato cultivars, which express resistance genes acting against Phytophthora infestans derived from the mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

Furthermore, plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

Modified plants, which are suitable to be used in the methods of the present invention, are those, which are rendered tolerant to herbicides, in particular tolerant to glyphosate, most preferably those glyphosate tolerant plants set forth above.

Modified plants, which are particularly suitable to be used in the methods of the present invention, are those, which are rendered tolerant to herbicides, in particular tolerant to dicamba, most preferably those dicamba tolerant plants set forth above.

Modified plants, which are particularly suitable to be used in the methods of the present invention, which are rendered tolerant to herbicides, in particular tolerant to both dicamba and glyphosate, most preferably those dicamba+glyphosate tolerant plants set forth above.

### EXAMPLES

The figures and examples below serve to illustrate the invention:

### Example 1

### Complex I (Dicamba/Caffeine)

### Preparation

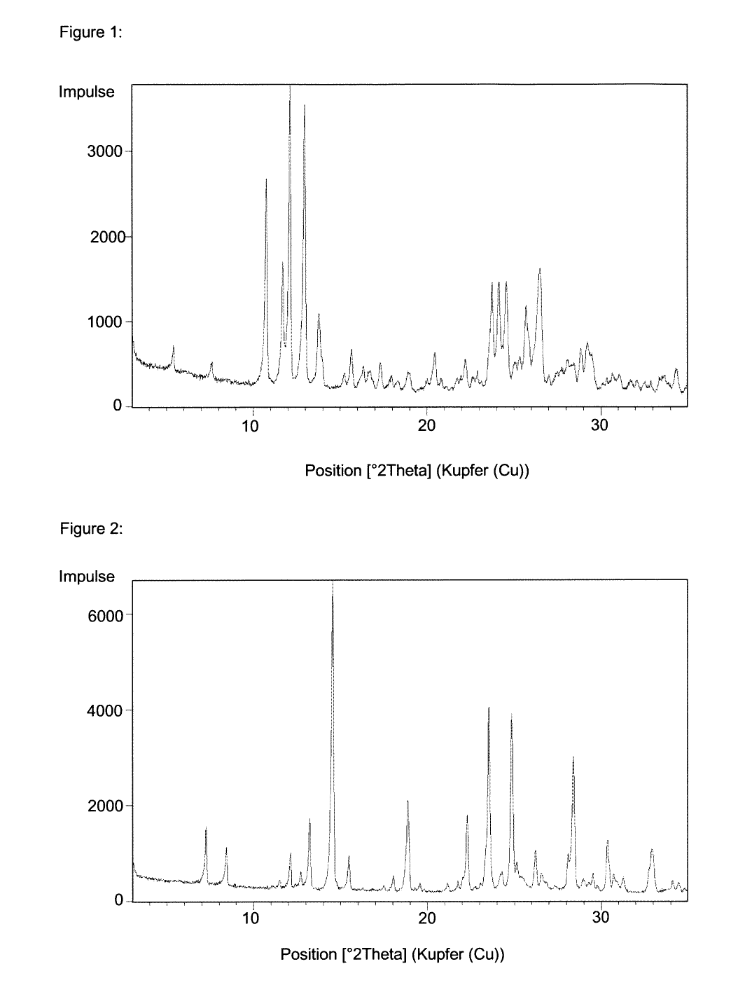

For a 1:1 co-crystal of dicamba and caffeine, 106 mg of dicamba, 94 mg of caffeine and 80 μl of 50 v/v-% water-ethanol or nitromethane solution was grinded in a ball mill (Retsch Modell MM301) for 20 minutes. The residual solvents were left to dry in air. The crystalline product gave the PXRD presented in FIG. 1.

FIG. 1. XRPD pattern of the co-crystal (Complex I) comprising dicamba and caffeine

The co-crystal of dicamba and caffeine (Complex I) shows an X-ray powder diffractogram at 25° C. (Cu-Kα radiation, 1.54060 Å;) wherein the characteristic reflexes of the pure compounds are missing. In particular, the co-crystal of dicamba and caffeine shows at least 5, preferably at least 7, in particular at least 9 and more preferably all of the following reflexes, given in the following table 1 as 2θ values:

```
TABLE 1
PXRD of the co-crystal of dicamba and caffeine (Complex I)
(25° C., Cu-radiation, 1,5406 Å)
2θ values
  5.41 ± 0.2°
  7.64 ± 0.2°
10.78 ± 0.2°
11.72 ± 0.2°
12.14 ± 0.2°
12.97 ± 0.2°
13.77 ± 0.2°
23.75 ± 0.2°
24.14 ± 0.2°
24.55 ± 0.2°
26.58 ± 0.2°
```

The crystalline Complex I has typically a melting point in the range from 97° C. to 117° C., in particular in the range from 105° C. to 109° C.

### Example 2

### Complex II, Form I (Dicamba/Theophylline)

### Preparation

For a 1:1 co-crystal of dicamba and theophylline, 110 mg of dicamba, 90 mg of theophylline and 80 μl of 50 v/v-% water-ethanol or nitromethane solution was grinded in a ball mill (Retsch Modell MM301) for 20 minutes. The residual solvents were left to dry in air. The crystalline product gave the PXRD presented in FIG. 2.

FIG. 2. XRPD pattern of the co-crystal (Complex II) comprising dicamba and theophylline (Form I)

The co-crystal of dicamba and theophylline (Complex II) shows an X-ray powder diffractogram at 25° C. (Cu-Kα radiation, 1.54060 Å;) wherein the characteristic reflexes of the pure compounds are missing. In particular, the co-crystal of dicamba and theophylline shows at least 5, preferably at least 7, in particular at least 9 and more preferably all of the following reflexes, given in the following tables 2 or 3 as 2θ values:

```
TABLE 2
PXRD of the co-crystal of dicamba and theophylline (Complex II)
(Form I) (25° C., Cu-radiation, 1,5406 Å)
2θ values
  7.27 ± 0.2°
  8.44 ± 0.2°
11.52 ± 0.2°
12.14 ± 0.2°
12.75 ± 0.2°
13.25 ± 0.2°
14.57 ± 0.2°
15.49 ± 0.2°
18.05 ± 0.2°
18.90 ± 0.2°
22.29 ± 0.2°
23.54 ± 0.2°
24.86 ± 0.2°
28.40 ± 0.2°
```

### Example 3

### Complex II, Form II (Dicamba/Theophylline, Hydrate)

### Preparation

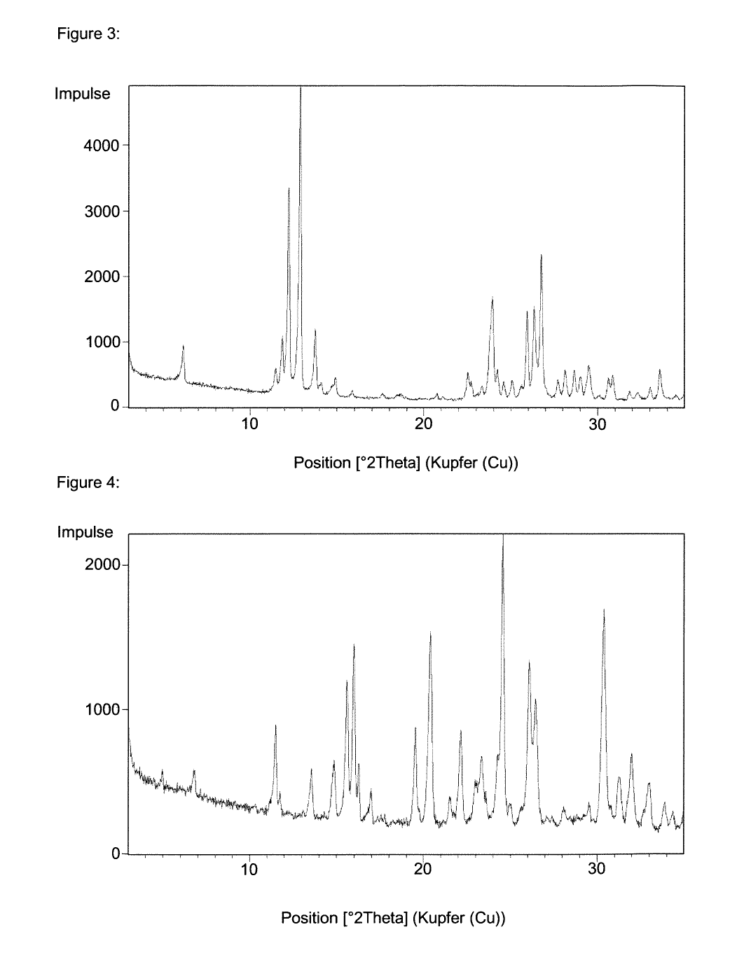

The 1:1 co-crystal of dicamba and theophylline was slurried for 12 hours in water. The solid was filtered and the residual solvents were left to dry in air. The crystalline product gave the PXRD presented in FIG. 3.

FIG. 3. XRPD pattern of the co-crystal (Complex II) comprising dicamba and theophylline (Form II)

TABLE 3
PXRD of the co-crystal of dicamba and theophylline (Form II)
(25° C., Cu-radiation, 1,5406 Å)
2θ values
6.15 ± 0.2°
11.50 ± 0.2°
11.87 ± 0.2°
12.27 ± 0.2°
12.92 ± 0.2°
13.80 ± 0.2°
14.13 ± 0.2°
14.94 ± 0.2°
18.05 ± 0.2°
15.86 ± 0.2°
22.52 ± 0.2°
23.95 ± 0.2°
25.92 ± 0.2°
26.34 ± 0.2°
26.75 ± 0.2°

Complex II has typically a melting point in the range from 121° C. to 141° C., in particular in the range from 129° C. to 133° C.

### Example 4

### Complex III (Dicamba/2-Aminopyrimidine)

### Preparation

For a 1:1 co-crystal of dicamba and 2-aminopyrimidine, 140 mg of dicamba, 60 mg of 2-aminopyrimidine and 80 μl of 50 v/v-% water-ethanol or nitromethane solution was grinded in a ball mill (Retsch Modell MM301) for 20 minutes. The residual solvents were left to dry in air. The crystalline product gave the PXRD presented in FIG. 4. FIG. 4. XRPD pattern of the co-crystal (Complex III) comprising dicamba and 2-aminopyrimidine

The co-crystal of dicamba and 2-aminopyrimidine (Complex III) shows an X-ray powder diffractogram at 25° C. (Cu-Kα radiation, 1.54060 Å;) wherein the characteristic reflexes of the pure compounds are missing. In particular, the co-crystal of dicamba and 2-aminopyrimidine shows at least 5, preferably at least 7, in particular at least 9 and more preferably all of the following reflexes, given in the following table 4 as 2θ values:

TABLE 4
PXRD of the co-crystal of dicamba and 2-aminopyrimidine (Complex III)
(25° C., Cu-radiation, 1,5406 Å)
2θ values
6.85 ± 0.2°
11.52 ± 0.2°
13.59 ± 0.2°
14.90 ± 0.2°
15.61 ± 0.2°
16.00 ± 0.2°
16.26 ± 0.2°
16.98 ± 0.2°
19.54 ± 0.2°
20.40 ± 0.2°
24.54 ± 0.2°
26.07 ± 0.2°
26.48 ± 0.2°
30.41 ± 0.2°

Complex III has typically a melting point in the range from 99° C. to 119° C., in particular in the range from 107° C. to 111° C.

### Example 5

### Complex IV (Dicamba/4-Aminopyrimidine)

### Preparation

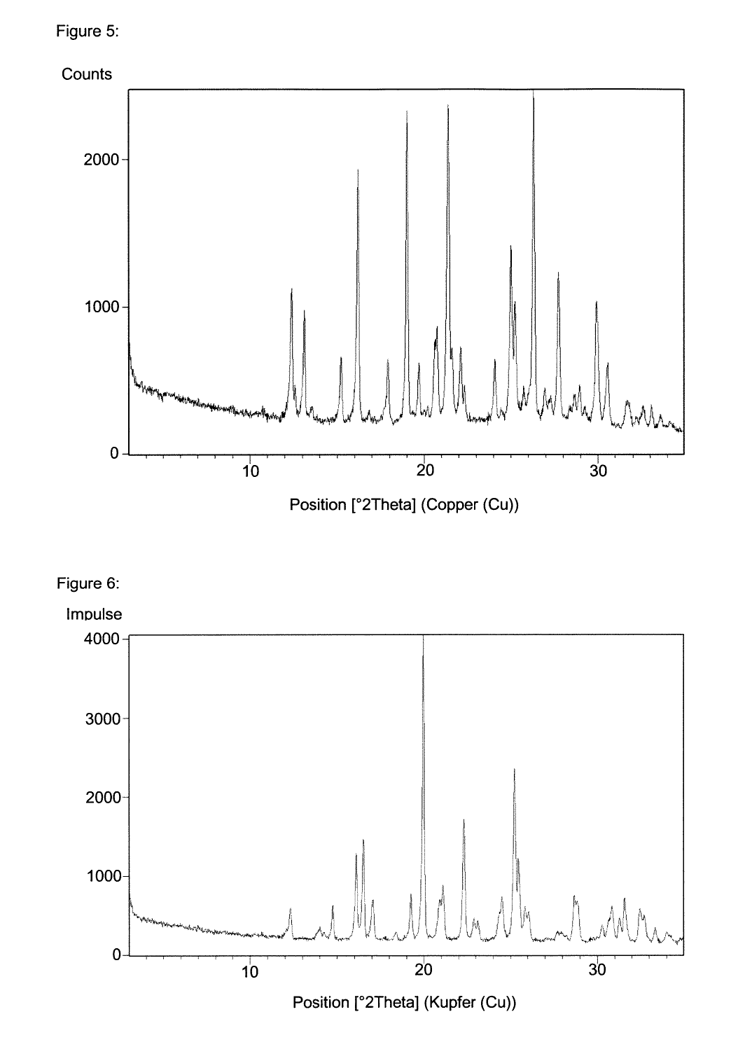

For a 1:1 co-crystal of dicamba and 4-aminopyrimidine, 140 mg of dicamba, 60 mg of 4-aminopyrimidine and 80 μl of 50 v/v-% water-ethanol or nitromethane solution was grinded in a ball mill (Retsch Modell MM301) for 20 minutes. The residual solvents were left to dry in air. The crystalline product gave the PXRD presented in FIG. 5.

FIG. 5. XRPD pattern of the co-crystal (Complex IV) comprising dicamba and 4-aminopyrimidine

The co-crystal of dicamba and 4-aminopyrimidine (Complex IV) shows an X-ray powder diffractogram at 25° C. (Cu-Kα radiation, 1.54060 Å;) wherein the characteristic reflexes of the pure compounds are missing. In particular, the co-crystal of dicamba and 4-aminopyrimidine shows at least 5, preferably at least 7, in particular at least 9 and more preferably all of the following reflexes, given in the following table 5 as 20 values:

TABLE 5
PXRD of the co-crystal of dicamba and 4-aminopyrimidine
(25° C., Cu-radiation, 1,5406 Å)
2θ values
12.40 ± 0.2°
13.13 ± 0.2°
15.23 ± 0.2°
16.20 ± 0.2°
17.92 ± 0.2°
19.03 ± 0.2°
21.38 ± 0.2°
25.01 ± 0.2°
25.22 ± 0.2°
26.30 ± 0.2°
27.72 ± 0.2°
29.93 ± 0.2°

Complex IV has typically a melting point in the range from 111° C. to 131° C., in particular in the range from 119° C. to 123° C.

### Example 6

### Complex V (Dicamba/2-Aminothiazole)

### Preparation

For a 1:1 co-crystal of dicamba and 2-aminothiazole, 138 mg of dicamba, 62 mg of 2-aminothiazole and 80 μl of 50 v/v-% water-ethanol or nitromethane solution was grinded in a ball mill (Retsch Modell MM301) for 20 minutes. The residual solvents were left to dry in air. The crystalline product gave the PXRD presented in FIG. 6.

FIG. 6. XRPD pattern of the co-crystal (Complex V) comprising dicamba and 2-aminothiazole

The co-crystal of dicamba and 2-aminothiazole (Complex V) shows an X-ray powder diffractogram at 25° C. (Cu-Kα radiation, 1.54060 Å;) wherein the characteristic reflexes of the pure compounds are missing. In particular, the co-crystal of dicamba and 2-aminothiazole shows at least 5, preferably at least 7, in particular at least 9 and more preferably all of the following reflexes, given in the following table 6 as 2θ values:

TABLE 6
PXRD of the co-crystal of dicamba and 2-aminothiazole
(25° C., Cu-radiation, 1,5406 Å)
2θ values
12.32 ± 0.2°
14.01 ± 0.2°
14.76 ± 0.2°
16.11 ± 0.2°
16.53 ± 0.2°
17.07 ± 0.2°
19.25 ± 0.2°
19.97 ± 0.2°
20.88 ± 0.2°
21.11 ± 0.2°
22.30 ± 0.2°
25.23 ± 0.2°
25.47 ± 0.2°

Complex V has typically a melting point in the range from 122° C. to 142° C., in particular in the range from 130° C. to 134° C.

### Example 7

### Complex VI (Dicamba/3-Hydroxypyridine)

### Preparation

For a 1:1 co-crystal of dicamba and 3-hydroxipyridine, 140 mg of dicamba, 60 mg of 3-hydroxypiridine and 80 μl of 50 v/v-% water-ethanol or nitromethane solution was grinded in a ball mill (Retsch Modell MM301) for 20 minutes. The residual solvents were left to dry in air. The crystalline product gave the PXRD presented in Figure VII.

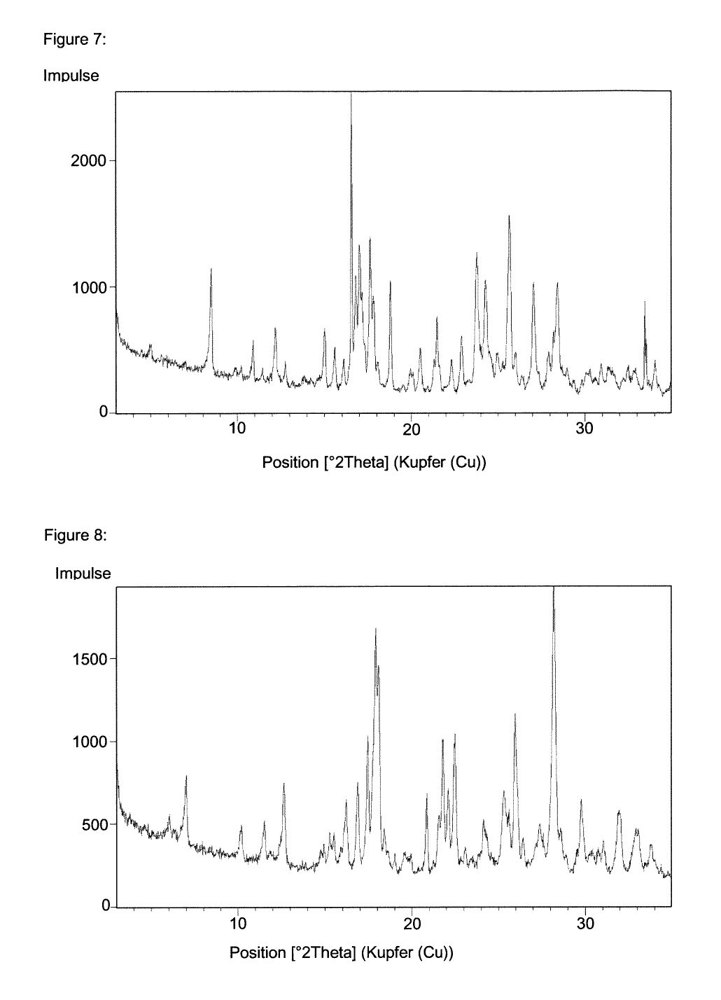

FIG. 7. XRPD pattern of the co-crystal (Complex VI) comprising dicamba and 3-hydroxypyridine

The co-crystal of dicamba and 3-hydroxypyridine (Complex VI) shows an X-ray powder diffractogram at 25° C. (Cu-Kα radiation, 1.54060 Å;) wherein the characteristic reflexes of the pure compounds are missing. In particular, the co-crystal of dicamba and 3-hydroxypyridine shows at least 5, preferably at least 7, in particular at least 9 and more preferably all of the following reflexes, given in the following table 7 as 2θ values:

TABLE 7
PXRD of the co-crystal of dicamba and 3-hydroxypyridine (Complex VI)
(25° C., Cu-radiation, 1,5406 Å)
2θ values
8.50 ± 0.2°
12.22 ± 0.2°
12.78 ± 0.2°
15.05 ± 0.2°
16.55 ± 0.2°
17.63 ± 0.2°
18.80 ± 0.2°
23.82 ± 0.2°
24.29 ± 0.2°
25.67 ± 0.2°
27.07 ± 0.2°
28.46 ± 0.2°

Complex VI has typically a melting point in the range from 110° C. to 130° C., in particular in the range from 118° C. to 122° C.

### Example 8

### Complex VII, Form I (Dicamba/Isocytosine)

### Preparation

For a 1:1 co-crystal of dicamba and isocytosine, 133 mg of dicamba, 67 mg of isocytosine and 80 μl of 50 v/v-% water-ethanol or nitromethane solution was grinded in a ball mill (Retsch Modell MM301) for 20 minutes. The residual solvents were left to dry in air. The crystalline product gave the PXRD presented in Figure VIII.

FIG. 8. XRPD pattern of the co-crystal (Complex VII) comprising dicamba and isocytosine (Form I)

The co-crystal of dicamba and isocytosine (Complex VII) shows an X-ray powder diffractogram at 25° C. (Cu-Kα radiation, 1.54060 Å;) wherein the characteristic reflexes of the pure compounds are missing. In particular, the co-crystal of dicamba and isocytosine shows at least 5, preferably at least 7, in particular at least 9 and more preferably all of the following reflexes, given in the following tables 8 or 9 as 2θ values:

TABLE 8
PXRD of the co-crystal of dicamba and isocytosine (Complex VII)
(Form I) (25° C., Cu-radiation, 1,5406 Å)
2θ values
7.02 ± 0.2°
10.18 ± 0.2°
11.54 ± 0.2°
12.68 ± 0.2°
16.23 ± 0.2°
16.91 ± 0.2°
17.46 ± 0.2°
17.91 ± 0.2°
18.12 ± 0.2°
25.31 ± 0.2°
28.22 ± 0.2°

### Example 9

### Complex VII, Form II (Dicamba/Isocytosine)

### Preparation

The 1:1 co-crystal of dicamba and isocytosine was slurried for 12 hours in water. The solid was filtered and the residual solvents were left to dry in air. The crystalline product gave the PXRD presented in FIG. 3.

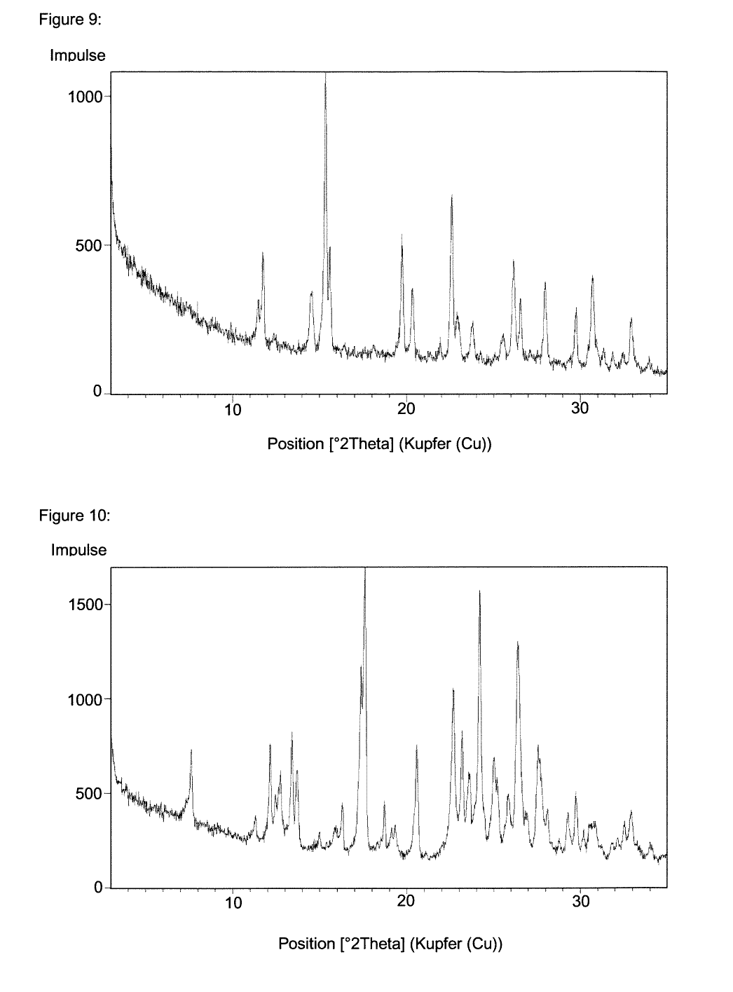

FIG. 9. XRPD pattern of the co-crystal (Complex VII) comprising dicamba and isocytosine (Form II)

TABLE 9
PXRD of the co-crystal of dicamba and isocytosine (Complex VII)
(Form II) (25° C., Cu-radiation, 1,5406 Å)
2θ values
11.44 ± 0.2°
11.79 ± 0.2°
14.55 ± 0.2°
15.35 ± 0.2°
15.58 ± 0.2°
19.73 ± 0.2°
20.34 ± 0.2°
22.62 ± 0.2°
23.77 ± 0.2°
25.52 ± 0.2°
26.16 ± 0.2°
26.57 ± 0.2°
27.97 ± 0.2°
29.77 ± 0.2°
30.71 ± 0.2°

Complex VII has typically a melting point in the range from 175° C. to 195° C., in particular in the range from 183° C. to 187° C.

### Example 10

### Complex VIII (Dicamba/4,4′-Bipyridine)

### Preparation

For a 2:1 co-crystal of dicamba and 4,4′-bipyridine, 148 mg of dicamba, 52 mg of 4,4′-bipyridine and 80 μl of 50 v/v-% water-ethanol or nitromethane solution was grinded in a ball mill (Retsch Modell MM301) for 20 minutes. The residual solvents were left to dry in air. The crystalline product gave the PXRD presented in FIG. 10.

FIG. 10. XRPD pattern of the co-crystal (Complex VIII) comprising dicamba and 4,4′-bipyridine

The co-crystal of dicamba and 4,4′-bipyridine (Complex VIII) shows an X-ray powder diffractogram at 25° C. (Cu-Kα radiation, 1.54060 Å;) wherein the characteristic reflexes of the pure compounds are missing. In particular, the co-crystal of dicamba and 4,4′-bipyridine shows at least 5, preferably at least 7, in particular at least 9 and more preferably all of the following reflexes, given in the following table 10 as 2θ values:

TABLE 10
PXRD of the co-crystal of dicamba and 4,4′-bipyridine
(Complex VIII) (25° C., Cu-radiation, 1,5406 Å)
2θ values
7.64 ± 0.2°
11.29 ± 0.2°
12.17 ± 0.2°
12.75 ± 0.2°
13.44 ± 0.2°
13.74 ± 0.2°
17.62 ± 0.2°
20.60 ± 0.2°
22.68 ± 0.2°
23.19 ± 0.2°
23.66 ± 0.2°
24.20 ± 0.2°
26.40 ± 0.2°

Complex VIII has typically a melting point in the range from 93° C. to 113° C., in particular in the range from 101° C. to 105° C.

### Crystallographic Analysis of the Co-Crystals

The X-ray powder diffractograms were recorded using a Panalytical X′Pert Pro diffractometer (manufacturer: Panalytical) in reflection geometry in the range from 2θ=3°-35° C. with increments of 0.0167° C. using Cu-Kα radiation (at 25° C. The recorded 2θ values were used to calculate the stated interplanar spacings d. The intensity of the peaks (y-axis: linear intensity counts) is plotted versus the 20 angle (x-axis in degrees 2θ).

The single crystal X-ray diffraction data was collected on a Bruker AXS CCD Detector using graphite Cu-Kα radiation. The structures were solved using direct methods, refined and expanded by using Fourier techniques with SHELX software package (G. M. Sheldrick, SHELX-97, University of Gottingen, 1997). Absorption correction was performed with SADABS software.

### Thermal Analysis of the Co-Crystals

DSC-measurement was carried out on a Mettler-Toledo DSC 823 instrument. An open aluminium pan was used and the measurement was carried out under nitrogen flow with a heating rate of 5° C./min and a sample weight of 5 to 10 mg.

TG/DTA measurement was carried out on a Seiko TG/DTA 7200 instrument. An open aluminium pan was used and the measurement was carried out under nitrogen flow with a sample weight of 5 to 10 mg. The isothermal TGA for volatility studies were performed at 100° C. and the weight loss was monitored for 12 hours.

### Water Solubility of the Co-Crystals

The determination of the amount of the actives in solution was performed on HPLC ACQUITY (Water) system, equipped with PDA_{—}230 nm UV detector and Sample Manager auto-injector. Waters' Enpower software was used to record the chromatograms and to calculate the chromatographic parameters. Gradient elution (Acetonitrile—0.1% H₃PO₄) was achieved using C18 column, 50×2.1 mm, 1.7 μm BEH. Injection volume was set 1 μL by auto injector. The analysis were performed with rate flux of 0.4 ml/min. UV detection was performed at 245 nm. Peak identities were confirmed by spectrum and retention time comparison. All the analyses were performed at room temperature. All the analyzed solutions were prepared by slurry equilibration experiments. Particularly, water suspensions of dicamba and the corresponding Complexes I to VIIII were slurried for 24 hours, according with the maximum value of the intrinsic dissolution profile of the pure active. The suspensions were filtered and both solid phase and liquid phase were analyzed by XRPD and HPLC, respectively.

TABLE 11
Physicochemical Properties

| | | | TGA Volatility |
|---|---|---|---|
| | | Solubility | (% weight loss per |
| Compound | Melting Point (° C.) | (mg/L) | minute) |
| Dicamba | 115 | 6550 | 1.20 × 10⁻² |
| Complex I | 107 | 4000 | — |
| Complex II | 131 | 2446 | 5.45 × 10⁻³ |
| Complex III | 109 | 13016 | — |
| Complex IV | 121 | 11921 | — |
| Complex V | 132 | 11185 | 9.61 × 10⁻² |
| Complex VI | 120 | 12535 | 4.63 × 10⁻³ |
| Complex VII | 185 | 4493 | 1.59 × 10⁻³ |
| Complex VIII | 103 | 5904 | 4.50 × 10⁻³ |

### Crystal Structure Determination

The reported single crystal structures were determined at −170° C. The co-crystals comprise dicamba and the corresponding co-crystal former in 1:1 or 2:1 ratio. The supramolecular architectures are based on OH . . . N hydrogen bonded motifs. No complete proton transfer occurs, supporting the co-crystallisation rather than the salification. The characteristic data of the known crystal structures are shown in tables 12-17

TABLE 12
Crystallographic data of the crystalline co-crystal Complex II
comprising dicamba and theophylline (Form II, hydrate)

| Parameter | |
|---|---|
| Crystal system | Triclinic |
| Space group | P-1 |
| a | 7.6836(3) |
| b | 8.1088(4) |
| c | 14.7017(6) |
| α | 100.453(2) |
| β | 90.952(2) |
| γ | 105.226(2) |
| Volume | 867.2 |
| Z | 2 |
| 4.76 | 10.22 |

a, b, c = Length of the edges of the unit cell
α, β, γ = Angles of the unit cell
Z = Number of molecules, in the unit cell

TABLE 13
Crystallographic data of the crystalline co-crystal Complex III
comprising dicamba and 2-aminopyrimidine

| Parameter | |
|---|---|
| Crystal system | Triclinic |
| Space group | P-1 |
| a | 6.3513(4) |
| b | 8.4983(5) |
| c | 13.4271(8) |
| α | 72.711(2) |
| β | 80.437(3) |
| γ | 69.938(2) |
| Volume | 648.3 |
| Z | 2 |
| 4.76 | 5.82 |

a, b, c = Length of the edges of the unit cell
α, β, γ = Angles of the unit cell
Z = Number of molecules, in the unit cell

TABLE 14
Crystallographic data of the crystalline co-crystal Complex V
comprising dicamba and 2-aminothiazole

| Parameter | |
|---|---|
| Crystal system | Monoclinic |
| Space group | P2₁/c |
| a | 12.4568(5) |
| b | 8.9125(3) |
| c | 12.1528(5) |
| α | 90 |
| β | 92.096(1) |
| γ | 90 |
| Volume | 1348.3 |
| Z | 4 |
| 3.52 | 5.82 |

a, b, c = Length of the edges of the unit cell
α, β, γ = Angles of the unit cell
Z = Number of molecules, in the unit cell

TABLE 15
Crystallographic data of the crystalline co-crystal Complex VI
comprising dicamba and 3-hydroxypyridine

| Parameter | |
|---|---|
| Crystal system | Triclinic |
| Space group | P-1 |
| a | 7.4377(8) |
| b | 9.0224(1) |
| c | 10.8321(1) |
| α | 94.390(5) |
| β | 107.148(5) |
| γ | 97.457(4) |
| Volume | 683.4 |
| Z | 2 |
| 3.52 | 21.43 |

a, b, c = Length of the edges of the unit cell
α, β, γ = Angles of the unit cell
Z = Number of molecules, in the unit cell

TABLE 16
Crystallographic data of the crystalline co-crystal Complex VII
comprising dicamba and isocytosine (Form II)

| Parameter | |
|---|---|
| Crystal system | Triclinic |
| Space group | P-1 |
| a | 6.4000(1) |
| b | 8.4000(1) |
| c | 13.7700(3) |
| α | 74.36(3) |
| β | 80.28(3) |
| γ | 68.48(3) |
| Volume | 667.3 |
| Z | 2 |
| 3.52 | 8.08 |

a, b, c = Length of the edges of the unit cell
α, β, γ = Angles of the unit cell
Z = Number of molecules, in the unit cell

TABLE 17
Crystallographic data of the crystalline co-crystal Complex VIII
comprising dicamba and 4,4′-bipyridine

| Parameter | |
|---|---|
| Crystal system | Triclinic |
| Space group | P-1 |
| a | 7.7025(4) |
| b | 14.6605(1) |
| c | 23.0835(6) |
| α | 84.259(1) |
| β | 87.155(1) |
| γ | 85.725(1) |
| Volume | 2584.1 |
| Z | 8 |
| 3.52 | 8.26 |

a, b, c = Length of the edges of the unit cell
α, β, γ = Angles of the unit cell
Z = Number of molecules, in the unit cell

1-21. (canceled)

22. Co-crystals comprising
a) a herbicide compound A, which is 3,6-dichloro-2-methoxybenzoic acid (dicamba), and
b) a co-crystal former B, which is selected from the group consisting of caffeine, theophylline, 2-aminopyrimidine, 4-aminopyrimidine, 2-aminothiazole, 3-hydroxypyridine, isocytosine and 4,4′-bipyridine.

23. The co-crystals as claimed in claim 22, wherein the molar ratio of the herbicide compound A and the co-crystal former B is from 2:1 to 1:2.

24. The co-crystal as claimed in claim 22, wherein the co-crystal former B is caffeine and an X-ray powder diffractogram at 25° C. and Cu radiation shows at least five of the following diffraction lines, given as 2θ values:
5.41±0.2°, 7.64±0.2°, 10.78±0.2°, 11.72±0.2°, 12.14±0.2°, 12.97±0.2°, 13.77±0.2°, 23.75±0.2°, 24.14±0.2°, 24.55±0.2°, 26.58±0.2°.

25. The co-crystal as claimed in claim 22, wherein the co-crystal former B is theophylline and an X-ray powder diffractogram at 25° C. and Cu radiation shows at least five of the following diffraction lines, given as 2θ values:
a) 7.27±0.2°, 8.44±0.2°, 11.52±0.2°, 12.14±0.2°, 12.75±0.2°, 13.25±0.2°, 14.57±0.2°, 15.49±0.2°, 18.05±0.2°, 18.90±0.2°, 22.29±0.2°, 23.54±0.2°, 24.86±0.2°, 28.40±0.2° (Form I); or
b) 6.15±0.2°, 11.50±0.2°, 11.87±0.2°, 12.27±0.2°, 12.92±0.2°, 13.80±0.2°, 14.13±0.2°, 14.94±0.2°, 15.86±0.2°, 22.52±0.2°, 23.95±0.2°, 25.92±0.2°, 26.34±0.2°, 26.75±0.2° (Form II, hydrate).

26. The co-crystal as claimed in claim 22, wherein the co-crystal former B is 2-aminopyrimidine and an X-ray powder diffractogram at 25° C. and Cu radiation shows at least five of the following diffraction lines, given as 2θ values: 6.85±0.2°, 11.52±0.2°, 13.59±0.2°, 14.90±0.2°, 15.61±0.2°, 16.00±0.2°, 16.26±0.2°, 16.98±0.2°, 19.54±0.2°, 20.40±0.2°, 24.54±0.2°, 26.07±0.2°, 26.48±0.2°, 30.41±0.2°.

27. The co-crystal as claimed in claim 22, wherein the co-crystal former B is 4-aminopyrimidine and an X-ray powder diffractogram at 25° C. and Cu radiation shows at least five of the following diffraction lines, given as 2θ values: 12.40±0.2°, 13.13±0.2°, 15.23±0.2°, 16.20±0.2°, 17.92±0.2°, 19.03±0.2°, 21.38±0.2°, 25.01±0.2°, 25.21±0.2°, 26.30±0.2°, 27.72±0.2°, 29.93±0.2°.

28. The co-crystal as claimed in claim 22, wherein the co-crystal former B is 2-aminothiazole and an X-ray powder diffractogram at 25° C. and Cu radiation shows at least five of the following diffraction lines, given as 2θ values: 12.32±0.2°, 14.01±0.2°, 14.76±0.2°, 16.11±0.2°, 16.53±0.2°, 17.07±0.2°, 19.25±0.2°, 19.97±0.2°, 20.88±0.2°, 21.11±0.2°, 22.30±0.2°, 25.23±0.2°, 25.47±0.2°.

29. The co-crystal as claimed in claim 22, wherein the co-crystal former B is 3-hydroxypyridine and an X-ray powder diffractogram at 25° C. and Cu radiation shows at least five of the following diffraction lines, given as 2θ values: 8.50±0.2°, 12.22±0.2°, 12.78±0.2°, 15.05±0.2°, 16.55±0.2°, 17.63±0.2°, 18.80±0.2°, 23.82±0.2°, 24.29±0.2°, 25.67±0.2°, 27.07±0.2°, 28.46±0.2°.

30. The co-crystal as claimed in claim 22, wherein the co-crystal former B is isocytosine and an X-ray powder diffractogram at 25° C. and Cu radiation shows at least five of the following diffraction lines, given as 2θ values:
a) 7.02±0.2°, 10.18±0.2°, 11.54±0.2°, 12.68±0.2°, 16.23±0.2°, 16.91±0.2°, 17.46±0.2°, 17.91±0.2°, 18.12±0.2°, 25.31±0.2°, 28.22±0.2° (Form I); or
b) 11.44±0.2°, 11.79±0.2°, 14.55±0.2°, 15.35±0.2°, 15.58±0.2°, 19.73±0.2°, 20.34±0.2°, 22.62±0.2°, 23.77±0.2°, 25.52±0.2°, 26.16±0.2°, 26.57±0.2°, 27.97±0.2°, 29.77±0.2°, 30.71±0.2° (Form II).

31. The co-crystal as claimed in claim 22, wherein the co-crystal former B is 4,4′-bipyridine and an X-ray powder diffractogram at 25° C. and Cu radiation shows at least five of the following diffraction lines, given as 2θ values:
7.64±0.2°, 11.29±0.2°, 12.17±0.2°, 12.75±0.2°, 13.44±0.2°, 13.74±0.2°, 17.62±0.2°, 20.60±0.2°, 22.68±0.2°, 23.19±0.2°, 23.66±0.2°, 24.20±0.2°, 26.40±0.2°.

32. A process for preparing the co-crystals as claimed in claim 22, which comprises combining the herbicide compound A and the co-crystal former B in a suitable solvent.

33. The process according to claim 32, which is a solution process, a shear process or a slurry process.

34. An agrochemical composition comprising the co-crystals as claimed in claim 22 and formulation auxiliaries.

35. The agrochemical composition as claimed in claim 34, additionally comprising a further pesticide.

36. The agrochemical composition as claimed in claim 35, wherein the further pesticide is glyphosate.

37. The agrochemical composition as claimed in claim 34, wherein the composition is an aqueous suspension concentrate, a suspo-emulsion or water dispersable granules.

38. A method of controlling undesirable vegetation, which comprises allowing a composition as claimed in claim 34 to act on plants to be controlled or on their habitat.

39. The method as claimed in claim 38 in cultures of crop plants.

40. The method as claimed in claim 38, where the crop plants are tolerant towards the herbicide compound A.

41. The method as claimed in claim 41, where the crop plants additionally is tolerant towards glyphosate.
